(19) United States
(12) Patent Application Publication
(10) Pub. No.: US 2025/0122355 A1
(43) Pub. Date: Apr. 17, 2025

(54) METHOD OF TREATMENT OF A FIBER-REINFORCED COMPOSITE

(71) Applicant: SYENSQO SA, Brussels (BE)

(72) Inventors: Victor Ferrão, Campinas São Paulo (BR); Claude Billaud, Lyon (FR); Rawad Tadmouri, Bordeaux (FR)

(73) Assignee: SYENSQO SA, Brussels (BE)

(21) Appl. No.: 18/714,960

(22) PCT Filed: Nov. 23, 2022
(86) PCT No.: PCT/EP2022/082970

§ 371 Date: May 30, 2024

(30) Foreign Application Priority Data
Dec. 1, 2021 (EP) 21211615.6

(51) Int. Cl. C08J 11/22; C08J 11/10; C08K 7/06

(52) U.S. Cl. CPC C08J 11/22; C08J 11/105; C08K 7/06; C08J 2363/00

(57) ABSTRACT

The invention relates to a method of treatment of a fiber-reinforced epoxy composite which comprises contacting the fiber-reinforced epoxy composite with a bio-based solvent S chosen from levoglucosenone and/or a levoglucosenone derivative such as cyrene, wherein the treatment temperature generally exceeds by at least 10° C. the glass transition temperature of the fiber-reinforced epoxy composite.

### TECHNICAL FIELD

The present invention pertains to a method of treatment of a fiber-reinforced epoxy composite involving a particular organic solvent which can swell and exfoliate the fiber-reinforced epoxy composite, to related composite-solvent based compositions, and to processes involving said method of treatment for causing the degradation of the fiber-reinforced epoxy composite, recovering fibers therefrom and recycling the fibers.

### BACKGROUND ART

The global demand for fiber-reinforced epoxy composites, especially for carbon fiber-reinforced epoxy composites (CFRPs embedded in an epoxy resin), has sharply increased over the last few years, as the demand for lightweight materials has increased. Due to the absence of effective recycling methods, most composite waste has not been treated/recycled but sent to landfills. There remains a need for a robust and effective method to treat such composites and complete their life cycle.

Recycling of epoxy composites presents a daunting challenge because the epoxies are typically highly cross-linked, three-dimensional structures which are insoluble under mild conditions. Most efforts to recycle epoxy composites have largely focused on the recovery of the higher value component, viz. the reinforcing fibers. Accordingly, chemical treatments were preferentially developed, because of their potential capability of causing the degradation of the epoxy component without substantially impairing the reinforcing fibers (which mechanical and thermal treatments cannot offer).

Many of such chemical treatments were reported by Y. Ma and S. Nutt in Polymer Degradation and Stability, 2018, 153, 307-317, especially on p. 2 the introduction part. In this paper, Ma and Nutt study focused on the acid digestion on carbon fiber-reinforced amine/epoxy composites on the one hand, and on the depolymerization of the same composites using a supersaturated solution of benzyl alcohol and tripotassium phosphate on the other hand. In both cases, they observed that the degradation of the epoxy matrix resulting from the chemical treatment was very slow, and attributed it to the very low diffusion rate inside the highly cross-linked epoxy matrix.

To increase the diffusion rate inside epoxy matrices and speed up their degradation, Ma and Nutt developed two strategies. One was based on shredding of end-of-life composites intended to be pyrolysed, and did thus obviously not retain our attention. The other one consisted in a pretreatment whereby the composite was immersed in an organic solvent before initiating the chemical treatment itself, so as to physically “permeabilize” (swell) the composites without disrupting the fiber weave in the polymer matrix. As Ma and Nutt well explain, “the solvent penetrates the cross-linked network, enabling reactant molecules to reach cleavable bonds more easily <during the chemical treatment itself>, thus reducing eliminating the rate-limiting effect of diffusion. Different solvents were evaluated, including benzyl alcohol, xylene, diethylene glycol, dimethyl ether (DGDME), and diethylene glycol methyl ether (DGME). Trials determined that the most promising pre-treatment solvent was benzyl alcohol (solvent) at 40° C. above the matrix T_{g}, for 1.5 h per millimeter thickness of the laminate. The solvent pretreatment could be applied repeatedly, as no chemical reaction occurred during this step. In the second step, pre-treated composites were subjected to chemical reaction (acid digestion) to dissolve the epoxy matrix and separate clean fibers from the matrix”. The pretreatment proved to reduce or eliminate the rate-limiting effect of diffusion, and to increase substantially the degradation rate of the epoxy composite through subsequent acid digestion.

Although having demonstrated its efficiency and usefulness, Ma and Nutt's solvent pretreatment still suffers from a major drawback, viz. it requires the use of a solvent which is industrially made from an oil feedstock; so are benzyl alcohol, as well as the less performing solvents preliminary tested by these authors (xylene, diethylene glycol, DGDME and DGME). More specifically, benzyl alcohol is produced industrially from toluene via benzyl chloride, which is hydrolyzed; another route entails hydrogenation of benzaldehyde, a by-product of the oxidation of toluene to benzoic acid. Sustainability has become a more and more acute criterion, especially when operating a chemical process. There is a strong need for providing a pretreatment method as efficient as Ma and Nutt's solvent pretreatment method which would not require the use of a solvent issued from oil industry. There is a strong need for providing a solvent pretreatment method as efficient as Ma and Nutt's solvent pretreatment method, which would be based on a bio-based solvent, that is to say one which can be manufactured from a renewable biological feedstock, ideally a cheap and broadly available one. There is a need for identifying a bio-based solvent at least globally as efficient as benzyl alcohol in its ability to facilitate the subsequent chemical degradation of the epoxy contained in epoxy composite laminates, including through swelling (as described by Ma and Nutt) and exfoliation (about by Ma and Nutt remain silent).

Another room for improvement of Ma and Nutt's solvent pretreatment relates to the swelling ability of benzyl alcohol. An increased swelling of the fiber-reinforced composite is sometimes desirable to further permeabilize the composites and further reduce the rate-limiting effect of diffusion, especially in case of the most strongly “hardened” composites, which often comprise a highly cross-linked epoxy component. There is a need for identifying a solvent, desirably a bio-based solvent, capable of swelling a fiber-reinforced epoxy composite to a larger extent than what benzyl alcohol can do.

All these needs have remained unmet in spite of the high attention that was given to green solvents in general during the last few years. Among many other ones, it could be cited RHODIASOLV® family of eco-friendly solvents (commercially available from SOLVAY), and bio-based levoglucosenone and its derivatives, the most notorious of which is certainly cyrene (dihydrolevoglucosenone) which is commercialized by CIRCA. Levoglucosenone is made in a single step from cellulose, and can in turn be easily converted in one step into cyrene, as notably taught by Sherwood et al. in Chem. Commun., 2014, 50, 9650-9652. Insofar as levoglucosenone and its derivatives are concerned, Pacheco et al. in ChemSusChem, 2016, 9, 3503-3512 published a quite impressive study entitled “Intelligent Approach to Solvent Substitution: The Identification of a New Class of Levoglucosenone derivatives”. Through an in-depth review of the scientific literature, Pacheco et al. could identify, in addition to cyrene, not less than 164 levoglucosenone derivatives as bio-based solvent candidate molecules. All of them are listed in the “Supporting Information” accompanying Pacheco's paper. Relying on a theoretical approach using different models, notably Hansen solubility parameters, Pacheco selected some levoglucosenone derivatives which would be the best candidates for replacing some main conventional solvents, such as DCM, nitrobenzene, NMP, DCM, CHCl₃, THF, 1,2-DCEa, ethanol, acetone, DMF, DMSO, acetonitrile, etc. Among the 164 candidate molecules, Pacheco does neither disclose nor suggest any solvent that would be a good substitute for benzyl alcohol in Ma and Nutt's pretreatment; a fortiori, Pacheco does not point to levoglucosenone or to a levoglucosenone derivative as a solvent that would be able to swell a fiber-reinforced epoxy composite substantially more than what benzyl alcohol can do. In addition, the Applicant has noted that Hansen solubility parameters used by Pacheco seem to be a mix of values that were acquired through experimentation with values that were calculated from the molecule SMILE using a certain version of HSPiP software, which renders those values inconsistent with each other and the conclusions derived or derivable therefrom strongly challengeable, to say the least. The Applicant has also noted that Pacheco used a rather old version of the software (v4.1.xx, 2013), which is a priori less acknowledgeable than the most recent ones that have been put on the market (v5.3.xx).

Now, as the result of an in-depth study combining experimentation and reliable software calculations, the Applicant could identify a small set of levoglucosenone derivatives (corresponding to only 28% of Pacheco's candidates as bio-based solvents) which can meet the above recited needs, which serve as the basis for the present invention.

### Main Aspects of the Invention

The present invention concerns a method of treatment M of a fiber-reinforced epoxy composite which comprises contacting the fiber-reinforced epoxy composite with a solvent S at a treatment temperature Tₜᵣ,

wherein the solvent S is levoglucosenone and/or a levoglucosenone derivative of which the Hansen solubility parameters, as calculated from the SMILE of the solvent S using Yamamoto Molecular Breaking Method with HSPiP software version 5.3.06, comply with all the following requirements:

$$16 \leq δ D \leq 20$$

$$16 \leq δ P + δ H \leq 22$$

$$\frac{2}{5} \leq \frac{δ H}{δ P} \leq \frac{9}{5}$$

wherein δD is the energy from dispersion forces between molecules, δP is the energy from dipolar intermolecular forces between molecules and δH is the energy from hydrogen bonds between molecules, all three expressed in MPa^{0.5}, and
wherein the treatment temperature Tₜᵣ exceeds by at least 10° C. the glass transition temperature T_{g} of the fiber-reinforced epoxy composite as determined by DSC in accordance ASTM E1356-08(2014)
with the proviso that
when no glass transition temperature T_{g} can be detected by DSC in accordance ASTM E1356-08(2014), the treatment temperature Tₜᵣ satisfies at least one condition chosen from conditions (c1) to (c3),
wherein condition (c1) is that a glass transition temperature T_{g2} can be determined by DMA in accordance with ASTM D7028-07(2015) and the treatment temperature Tₜᵣ exceeds by at least 10° C. the glass transition temperature T_{g2},
wherein condition (c2) is that the treatment temperature Tₜᵣ, determined by trial-and-error experimentation, is such that the treatment causes the swelling of the fiber-reinforced epoxy composite by the solvent S with a swelling ratio r_{sw} of at least 8%, as determined after full immersion of the fiber-reinforced epoxy composite in the solvent S for 5 hours at the treatment temperature Tₜᵣ without stirring, and
wherein condition (c3) is that the treatment temperature is of at least 300° C.

The present invention concerns also:
a use of the solvent S as previously described for swelling a fiber-reinforced epoxy composite;
a composition comprising a fiber-reinforced epoxy composite and the solvent S as previously described;
a process P¹ for causing the degradation of an epoxy resin comprised in a fiber-reinforced epoxy composite, said process P¹ comprising:
   a) submitting the fiber-reinforced epoxy composite to a pretreatment, said pretreatment comprising applying the method M as previously described, and
   b) submitting the thus pretreated fiber-reinforced epoxy composite to an enzymatic treatment and/or a chemical treatment,
wherein each of a) and b) is performed once or several times;
a use of the method M for increasing the diffusion rate of an enzyme or a chemical compound in an epoxy resin embedded in a fiber-reinforced epoxy composite
a process P² for recovering reinforcing fibers from a fiber-reinforced epoxy composite which comprises:
   causing the degradation of the epoxy resin comprised in the fiber-reinforced epoxy composite by the process P¹ as previously described, thereby obtaining a material comprising carbon fibers and epoxy degradation products, and
   separating carbon fibers from the thus obtained material; and
a process P³ for recycling reinforcing fibers which comprises:
   recovering carbon fibers from a fiber-reinforced epoxy composite by the process P² as previously described; and
   manufacturing a composite material comprising a polymer and the thus recovered carbon fibers, said composite material being identical to or different from the fiber-reinforced epoxy composite material involved in the method M as previously described.

### DETAILED DESCRIPTION OF THE INVENTION

### Method of Treatment M

The method M comprises contacting the fiber-reinforced epoxy composite with a solvent S at a treatment temperature Tₜᵣ.

The method M can be in principle used with a solvent S in any physical state, including, solid, liquid, vapor or supercritical, as long a contact is established between the fiber-reinforced epoxy composite and the solvent S.

For the sake of easiness of implementation and efficiency, the solvent S is generally at liquid state. Also, the method is advantageously operated at atmospheric pressure (about 1 atm=101.325 kPa), although operating it under vacuum or in a pressurized vessel is also possible. Then, the solvent S has a melting point Tₘ which is below the treatment temperature Tₜᵣ, on the one hand, and a boiling point T_{b} which is above the treatment temperature Tₜᵣ, on the other hand.

The melting point and the boiling point of the solvent S can be determined by Differential Scanning Calorimetry (DSC). They are advantageously determined in accordance with OECD guideline (1995), Tests No. 102 and No. 103 respectively. It can be further relied on DIN 51005:2021-08, to which the aforementioned guidelines point. A DSC Q2000 calorimeter from TA Instruments can be used. The temperature program consists in one heating at a rate of 10° C./min.

The solvent S can be sprayed or poured onto the fiber-reinforced epoxy composite. Preferably, the fiber-reinforced epoxy composite is at least partially immersed in the solvent S. More preferably, at least about half of the initial mass (before treatment) of the fiber-reinforced epoxy composite is immersed in the solvent S. Still more preferably, the fiber-reinforced epoxy composite is fully immersed in the solvent S. By this way, an optimum contact can be achieved between the fiber-reinforced epoxy composite and the solvent S.

The fiber-reinforced epoxy composite may be contacted with the solvent S only. Alternatively, the solvent S may be used in combination with other agents, such as one or more solvent(s) other than the solvent S. Among such other solvents, green, bio-based and/or eco-friendly solvents are preferred. As an example of an eco-friendly solvent, it can be cited methyl 4-(dimethylcarbamoyl)-2-methylbutanoate, commercially available from SOLVAY as RHODIASOLV® Polarclean. Bio-based solvents other than the solvent S of particular interest are levoglucosenone derivatives the Hansen solubility parameters of which do not comply with the requirements established for the solvent S. As an example of such levoglucosenone derivatives, it is worth citing the some ketals of cyrene, of formulae

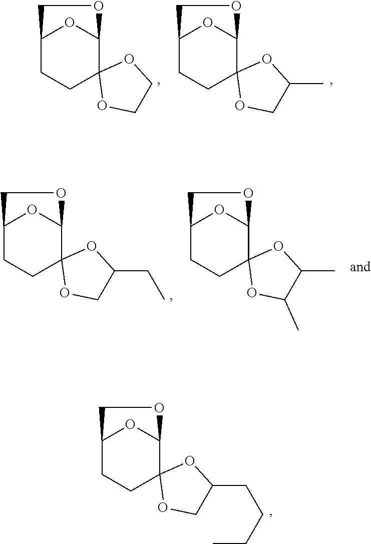

commonly known as Cygnet 0.0, Cygnet 1.0, Cygnet 2.0, Cygnet 1.1 and Cygnet 4.0 respectively, all of which being characterized by δP+δH<16.

During the treatment, the fiber-reinforcing epoxy composite and the solvent S may be kept at rest, or they may be put in relative movement with each other. For example, the fiber-reinforcing epoxy composite may be anchored to a fixed surface while the solvent S may be stirred. It is also possible to keep under agitation both the fiber-reinforcing epoxy composite and the solvent S. In a preferred embodiment, the fiber-reinforcing epoxy composite and the solvent S are kept at rest.

The weight ratio of the solvent S to the fiber-reinforcing epoxy composite that are involved in the method M can vary to a large extent, depending notably on the type of contact which is established between each other. For example, a low weight ratio can be used when the treatment is intended to be superficial. On the other hand and in general, the treatment is intended to provide an effect in the core of the fiber-reinforcing epoxy composite, hence the preference given to the full immersion of the fiber-reinforcing epoxy composite in the solvent S. Then, the solvent S involved in the method M is preferably used in an amount sufficient for it to enable the partial, preferably full immersion therein of the fiber-reinforcing epoxy composite. Having this in mind, the weight ratio of the solvent S to the fiber-reinforcing epoxy composite is generally of at least 1, and may be of at least 2, at least 5, at least 10, at least 20 or even at least 40. On the other hand, from an economic perspective, this ration is generally of at most 200, and may be of at most 100, at most 60 or at most 30.

The duration of the period of time during which the fiber-reinforcing epoxy composite and the solvent S are contacted with each other, especially the duration of the period of time during which the fiber-reinforced epoxy composite can be partially or fully immersed in the solvent S, may vary to a substantial extent, depending notably on the treatment temperature Tₜᵣ. Said duration ranges generally from 10 min to 100 hours. It is preferably of at least 30 min, more preferably of at least 1 hour, still more preferably of at least 2 hours and even more preferably at least 4 hours. For economic reasons, the duration may be no more than necessary to achieve the desired effect, generally the swelling of the composite with a sufficiently high swelling ratio r_{sw}; accordingly, it may be of at most 50 hours, at most 20 hours, at most 10 hours or at most 7 hours. A desired swelling ratio may be 5% or more. A desired swelling ratio is advantageously of at least 8%, preferably of at least 12%, more preferably of at least 15% and still more preferably of at least 18%.

Compared to the glass transition temperature T_{g} of the fiber-reinforced epoxy composite [as determined by DSC in accordance ASTM E1356-08(2014)], the treatment temperature Tₜᵣ must be sufficiently high to achieve the swelling of the composite with a sufficiently high swelling ratio r_{sw}, as above detailed. In accordance with the method M and subject to the previous proviso, the treatment temperature Tₜᵣ, especially the temperature at which the fiber-reinforced epoxy composite can be partially or fully immersed in the solvent S, must exceed by at least 10° C. the glass transition temperature T_{g} of the fiber-reinforced epoxy composite as determined by DSC in accordance ASTM E1356-08(2014). Tₜᵣ exceeds T_{g} preferably by at least 20° C., more preferably by at least 30° C. and still more preferably by at least 35° C. Tₜᵣ may exceed T_{g} by even more Celsius degrees, for example by at least 40° C., or even at least 50° C. However, for economic reasons and also to have at hand an as high as possible number of solvents S which remain liquid state at Tₜᵣ, Tₜᵣ does not advantageously exceed T_{g} by more than 200° C., preferably not by more than 100° C., more preferably not by more than 70° C. and still more preferably not by more than 50° C.

In general, a glass transition temperature T_{g} can be detected on the fiber-reinforced epoxy composite by DSC in accordance ASTM E1356-08(2014), so that such glass transition temperature T_{g} serves as the basis for determining the treatment temperature Tₜᵣ. To determine T_{g}, a DSC Q2000 calorimeter equipment from TA Instruments is advantageously used. The equipment has been well calibrated with a baseline (empty cell run under the standard DSC program conditions, viz. from room temperature—about 20° C.- to 350° C., with a heat rate of 10° C./min) and with indium calibration (from 100° C. to 180° C. at 10° C./min). A fiber-reinforced epoxy composite sample is prepared. An appropriate sample mass may be of from about 3 to about 12 mg; it may be adjusted depending on the whole fiber-reinforced epoxy composite composition, in particular its epoxy content. The sample is advantageously substantially thin and substantially flat so as to ensure good contact with a specimen holder into which it is put. The specimen holder is typically an Aluminum Tzero pan (available from TA Instruments) the lid of which is pierced; the pan is sealed for the test. The sample is heated from room temperature (about 20° C.) to 350° C. using a heating rate of 10° C. Importantly, no cooling program followed by a second heating program is applied: the T_{g} is determined during the first and only heating program; by doing so, it is avoided to determine the T_{g} on a sample the crosslinking degree or whatever other structural feature of the epoxy would have been substantially modified upon full completion of this first heating program. The measurement is run under a nitrogen flow gas of 50 m/min. The midpoint temperature, viz. the point on the thermal curve corresponding to ½ the heat flow difference between the extrapolated onset and extrapolated end, is defined as the glass transition temperature T_{g}.

Rarely, no glass transition temperature T_{g} can be detected by DSC in accordance ASTM E1356-08(2014). This situation can notably happen with a few highly cross-linked fiber-reinforced epoxy composites. Then, as above explained, the method M remains applicable subject that the treatment temperature Tₜᵣ satisfies at least one condition chosen from conditions (c1) to (c3).

The Applicant has observed that, for some fiber-reinforced epoxy composites, a glass transition temperature T_{g2} could be detected by Dynamic Mechanical Analysis (DMA) in accordance with ASTM D7028-07(2015), while no glass transition temperature T_{g} could be detected by DSC. Then, the method M can be applied notably when condition (c1) is satisfied. The condition (c1) requires that the treatment temperature Tₜᵣ exceeds by at least 10° C. the glass transition temperature T_{g2}. In preferred embodiments of (c1), Tₜᵣ exceeds T_{g2} by at least 20° C., more preferably by at least 30° C. and still more preferably by at least 35° C. Tₜᵣ may exceed T_{g2} by even more Celsius degrees, for example by at least 40° C., or even at least 50° C. Besides, Tₜᵣ does not advantageously exceed T_{g2} by more than 200° C., preferably not by more than 100° C., more preferably not by more than 70° C. and still more preferably not by more than 50° C.

For the DMA test, a Q800 dynamic mechanical analyzer from TA Instruments can be used. Flat, clean and dry rectangular strips specimens of a fiber-reinforced epoxy composite sample are advantageously prepared in accordance with the recommendations of the ASTM standard and the instrument manufacturer's manual. The specimens are properly conditioned to ensure their dryness. Two or more specimens may be tested for each sample, the case being the retained value for T_{g2} shall be the average value of each measurement, subject to possible removal of obviously flaw results. The specimen is placed in the DMA analyzer. Dual cantilever mode is possibly used with a clamp size of 35 mm (L), up to 15 mm (W) and 5 mm (T); in this mode, the specimen is clamped at both ends and flexed in the middle. The specimen is oscillated at a nominal frequency of 1 Hz in constant strain mode. The specimen is heated at a rate of 5° C./min (9° F./min) beginning at room temperature (about 20° C.) to an end temperature at least 50° C. above T_{g2}. Nitrogen may be used as purge gas. The temperature at which a significant drop in storage modulus (E′) begins is assigned as the glass transition temperature (T_{g2} or “DMA T_{g}”); more precisely, T_{g2} is determined to be the intersection of two tangent lines from the storage modulus.

Conditions (c2) and (c3) also address such rare instances when no glass transition temperature T_{g} can be detected by DSC in accordance ASTM E1356-08(2014). Conditions (c2) and (c3) can be embodied even when a glass transition temperature T_{g2} can be detected by Dynamic Mechanical Analysis (DMA) in accordance with ASTM D7028-07(2015). Having said this, conditions (c2) and (c3) are especially useful when no glass transition temperature T_{g} can be detected by DSC in accordance ASTM E1356-08(2014) and no glass transition temperature T_{g2} can be detected by Dynamic Mechanical Analysis (DMA) in accordance with ASTM D7028-07(2015). Although such instances are very rare, they may occur, notably with some very highly cross-linked fiber-reinforced epoxy composites.

In accordance with condition (c2), the treatment temperature Tₜᵣ is determined by trial-and-error experimentation, and is such that the treatment causes the swelling of the fiber-reinforced epoxy composite by the solvent S with a swelling ratio r_{sw} greater than or equal to a minimum value r_{sw,min} (here, 8%), as determined after full immersion of the fiber-reinforced epoxy composite in the solvent S for 5 hours at the treatment temperature Tₜᵣ without stirring; r_{sw,min} is preferably 12%, more preferably 15% and still more preferably of at least 18%. Determining a treatment temperature Tₜᵣ which results in a swelling ratio r_{sw}≥r_{sw,min} is especially easy for the skilled person. A single experiment is generally sufficient if the treatment is operated at a very high temperature Tₜᵣ (typically 300° C. or more, which strongly favors/ensures high swelling) and operating the treatment at such very high temperature is not problematic as there many solvents suitable as the solvent S that have a boiling point T_{b} above, possibly well above 300° C. As a matter of fact, the likelihood of success of a treatment operated at a treatment temperature Tₜᵣ of at least 300° C. (especially, of at least 350° C., at least 400° C. or even at least 450° C.) is extremely high because, from a practical standpoint, essentially all, when not all cured epoxies become softer and more rubbery at a temperature which is substantially below 300° C.; therefore, in practice, satisfying condition (c3), which “merely” provides to treat the fiber-reinforced epoxy composite at such a high, arbitrarily chosen, treatment temperature Tₜᵣ, has proven to be good enough to embody the method M of the present invention. It goes without saying that, in accordance with condition (c2), temperatures substantially lower than 300° C. can be tested for the treatment, still with a reasonably high expectation of success. Optimizing the treatment temperature Tₜᵣ and the choice of the solvent S can be achieved, if desired, as matter of routine by the skilled person.

As previously suggested, in accordance with condition (c3), the treatment temperature Tₜᵣ shall be of at least 300° C., and possibly of at least 350° C., at least 400° C. or even at least 450° C. Non limitative examples of solvents S deemed to be suitable for embodying condition (c3) have a boiling point, as predicted using Yamamoto Molecular Breaking Method with HSPiP software version 5.3.06, include solvents S13, S14, S39, S42, S52, S57, S58, S59, S75, S78, S80, S88, S96, S113, S119, S143, S156, S158, S160, S161 and S164, as labelled by Pacheco et al. and as used hereinafter in tables 2 to 12. Among them, solvents 557, 558, S59, S75, 5119, 5156, 5158, 5160, S161 and S164 have a predicted boiling point of at least 350° C., solvents S57, S58, S59, 5119 and S164 have a predicted boiling point of at least 400° C., S57, S58, S59 and S119 have a predicted boiling point of at least 450° C., and S58 has a predicted boiling point of 507° C. Based on a comparison made with various solvents including cyrene, the experimental boiling point of these solvents may be somewhat higher than their predicted boiling point.

In the rare instances when no glass transition temperature T_{g} can be detected by DSC in accordance ASTM E1356-08(2014), the skilled person may apply one of the following methodologies:
methodology 1: check whether a glass transition temperature T_{g2} can be determined by DMA in accordance with ASTM D7028-07(2015) and, if so, use a treatment temperature Tₜᵣ exceeding by at least 10° C. the glass transition temperature T_{g2}; then, if and only if no glass transition temperature can be detected by DMA in accordance with ASTM D7028-07(2015), then use a treatment temperature Tₜᵣ which satisfies the condition (c2) and/or (c3);
methodology 2: irrespectively of whether a glass transition temperature T_{g2} can be determined by DMA in accordance with ASTM D7028-07(2015), determine by trial-and-error experimentation a treatment temperature Tₜᵣ which satisfies the condition (c2) based on a swelling ratio r_{sw} of at least 8%;
methodology 3: irrespectively of whether a glass transition temperature T_{g2} can be determined by DMA in accordance with ASTM D7028-07(2015), use straightforward a treatment temperature Tₜᵣ which satisfies the condition (c3), viz. a treatment temperature of at least 300° C. (possibly of at least 350° C., at least 400° C. or even at least 450° C.).

The thus treated fiber-reinforced epoxy composite can be recovered from the solvent S through hot filtration.

The recovered fiber-reinforced epoxy composite can be washed with water, with an alcohol such as ethanol and/or a mixture thereof

### The Fiber-Reinforced Epoxy Composite

The fiber-reinforced epoxy composite comprises an epoxy resin and reinforcing fibers. It may consist essentially of or it may consist of an epoxy resin and a reinforcing fiber. Alternatively, it may further comprise one or more other component(s).

The reinforcing fibers are typically embedded in the epoxy resin, commonly referred to as the “matrix” of the composite, although the major component in weight of the composite may be the reinforcing fibers. It is typically a laminate.

The weight of the epoxy resin, based on the total weight of the composite, is generally of at least 10 wt % and often at least 25 wt %. It may be of at least 35 wt %, at least 50 wt % or at least 65 wt %. Besides, it is generally of at most 90 wt %, often at most 75 wt %.

Similarly, the weight of the reinforcing fibers, based on the total weight of the composite, is generally of at least 10 wt % and often of at least 25 wt %. It may be of at least 35 wt %, at least 50 wt % or at least 65 wt %. Besides, it is generally of at most 90 wt % and often at most 75 wt %.

The combined weight amount of the reinforcing fibers and the epoxy resin, based on the total weight of the composite, is generally greater than 50 wt %. It is often of at least 80 wt %, and may be of at least 90 wt %, at least 95 wt % or at least 99 wt %.

### The Epoxy Resin

The epoxy resin (or polyepoxide) comprised in the fiber-reinforced epoxy composite is generally a cured product. Curing is a process during which a chemical reaction takes place, so as to produce the toughening of hardening of the epoxy resin. The curing may be induced by UV or under the action of heat; however, the epoxy resin is generally cured by the use of additives, commonly referred to as curing agents or hardeners.

From a structural standpoint, the epoxy resin is generally a cross-linked product, the cross-linked structure resulting usually from the curing process. Hence, at temperatures much lower than the glass transition temperature T_{g} (or T_{g2}, as the case may be), for example at a temperature which is by 100° C. lower than the glass transition temperature, the epoxy resin comprised in the fiber-reinforced epoxy composite is generally substantially insoluble, essentially insoluble or fully insoluble in the solvent S involved in the present invention, which typically translates into a swelling ratio r_{sw} of less than 1.0%, as determined after full immersion of the fiber-reinforced epoxy composite in the solvent S for 5 hours at the temperature of concern without stirring.

Many fiber-reinforced epoxy composites of interest for the present invention have a glass transition temperature T_{g} (or T_{g2}, as the case may be) of 125° C. or more; then, their swelling ratio r_{sw}, as determined after full immersion of the fiber-reinforced epoxy composite in the solvent S for 5 hours at room temperature (about 20° C.) without stirring is typically below 1.0%. Fiber-reinforced epoxy composites of interest for the present invention have preferably a glass transition temperature T_{g} (or T_{g2}, as the case may be) of at least 145° C.; besides, their glass transition temperature is in general of at most 275° C. and often of at most 250° C.

Epoxy resins comprised in the fiber-reinforced epoxy composite of the present invention include bisphenol-based epoxy resins (which can be based on reacting epichlorhydrin with bisphenol A and/or with bisphenol F), novolaks (which can be based on reacting phenol with methanol, and possibly thereafter reacting the obtained novolak with epichlorhydrin), aliphatic epoxy resins, halogenated epoxy resins and glycidylamine epoxy resins (formed by reacting an aromatic amine with epichlorhydrin).

Epoxy resins comprised in the fiber-reinforced epoxy composite of the present invention can be based on at least one epoxy compound that has at least two epoxide groups per molecule. Such epoxy compounds can be aromatic, alicyclic or aliphatic. Suitable aromatic epoxy compounds include polyglycidyl ethers of phenols and of polyphenols, fluorene ring-bearing epoxy compounds, naphthalene ring-bearing epoxy compounds, dicyclopentadiene-modified phenolic epoxy compounds, epoxidized novolak or cresol novolak compounds, polyglycidyl adducts of amines (such as N,N-diglycidyl aniline), triglycidyl aminophenol (TGAP), triglycidyl aminocresol, tetraglycidyl xylenediamine, amino alcohols (such as triglycidyl aminophenol), polyglycidyl adducts of polycarboxylic acids (such as diglycidyl phthalate), polyglycidyl cyanurates (such as triglycidyl cyanurate), copolymers of glycidyl(meth)acrylates with copolymerizable vinyl compounds (such as styrene glycidyl methacrylate). Suitable alicyclic epoxy compounds include bis(2,3-epoxy-cyclopentyl)ether, copolymers of bis(2,3-epoxy-cyclopentyl)ether with ethylene glycols, dicyclopentadiene diepoxide, 4-vinyl cyclohexene dioxide, 3,4-epoxycyclohexylmethyl, 3,4-epoxycyclohexane carboxylate, 1,2,8,9-diepoxy limonene (limonene dioxide), 3,4-epoxy-6-methyl-cyclohexylmethyl, 3,4-epoxy-6-methylcyclohexane carboxylate, bis(3,4-epoxy-6-methylcyclohexylmethyl)adipate, 2-(7-oxabicyclo[4.1.0]hept-3-yl)spiro[1,3-dioxane-5,3′-[7]oxabicyclo[4.1.0]heptane], diepoxides of allyl cyclopentenyl ether, 1,4-cyclohexadiene diepoxide, 1,4-cyclohexanemethanol diglycidyl ether, bis(3,4-epoxycyclohexylmethyl) adipate, 3,4-epoxy-6-methylcyclohexane carboxylate, diglycidyl 1,2-cyclohexane carboxylate, 3,4-epoxycyclohexylmethyl methacrylate, 3-(oxiran-2-yl)-7-oxabicyclo[4.1.0]heptane, bis(2,3-epoxypropyl) cyclohex-4-ene-1,2-dicarboxylate, 4,5-epoxytetrahydrophthalic acid diglycidyl ester and poly[oxy(oxiranyl-1,2-cyclohexanediyl)] α-hydro-ω-hydroxy-ether, bi-7-oxabicyclo[4.1.0]heptane. Suitable aliphatic epoxy compounds include butanediol diglycidyl ether, epoxidized polybutadiene, dipentene dioxide, trimethylolpropane triglycidyl ether, bis[2-(2-butoxyethyoxy)ethyl)ethyl] adipate, hexanediol diglycidyl ether and hydrogenated bisphenol A epoxy resin.

The epoxy resin is preferably based on:
at least one aromatic compound A1 bearing at least two epoxide groups per molecule and comprising at least one aromatic ring bearing at least one glycidyloxy group, and
at least one curing agent A2.

The aromatic compound A1 corresponds advantageously to a diglycidyl ether of bisphenol, in particular a bisphenol A diglycidyl ether. The curing agent A2 is often an amine or an imidazole derivative.

More preferably, the epoxy resin is based on:
at least one aromatic compound A1 bearing at least two epoxide groups per molecule and comprising at least one aromatic ring bearing at least one glycidyloxy group, and
at least one curing agent A2.
optionally, at least one additional compound A3.

In some preferred embodiments, the epoxy resin is only based on:
at least one aromatic compound A1 bearing at least two epoxide groups per molecule and comprising at least one aromatic ring bearing at least one glycidyloxy group, and
at least one curing agent A2.

The expression “epoxy resin based on” should, of course, be understood as meaning an epoxy resin comprising the mixture and/or the reaction product of the various base constituents used for this composition, it being possible for some of them to be intended to react or capable of reacting with one another or with their immediate chemical surroundings, at least partly, during the various phases of manufacture of the fiber-reinforced epoxy composite or finished articles comprising such composite, in particular during the curing process which is generally applied. In other words, the epoxy resin is manufactured from at least one aromatic compound A1 as described below and at least one curing agent A2.

As used herein in reference to an organic compound A1 or A2, the term “aromatic” means that the organic compound that comprises one or more one aryl moieties, which may each optionally be interrupted by one or more heteroatoms, typically selected from oxygen, nitrogen, and sulfur heteroatoms, and one or more of the carbon atoms of one or more one aryl moieties may optionally be substituted with one or more organic groups, typically selected from alkyl, alkoxyl, hydroxyalkyl, cycloalkyl, alkoxyalkyl, haloalkyl, aryl, alkaryl, aralkyl.

As used herein in reference to an organic compound A1 or A2, the term “aryl” means cyclic, coplanar 5- to 14-membered organic group having a delocalized, conjugated π system, with a number of π electrons that is equal to 4n+2, where n is 0 or a positive integer, including compounds where each of the ring members is a carbon atom, such as benzene, compounds where one or more of the ring members is a heteroatom, typically selected from oxygen, nitrogen and sulfur atoms, such as furan, pyridine, imidazole, and thiophene, and fused ring systems, such as naphthalene, anthracene, and fluorene, wherein one or more of the ring carbons may be substituted with one or more organic groups, typically selected from alkyl, alkoxyl, hydroxyalkyl, cycloalkyl, alkoxyalkyl, haloalkyl, aryl, alkaryl, halo groups, such as, for example, phenyl, methylphenyl, trimethylphenyl, nonylphenyl, chlorophenyl, or trichloromethylphenyl.

As used herein, “epoxide group” means a vicinal epoxy group, i.e., a 1,2-epoxy group.

### The Aromatic Compound A1

The aromatic compound A1 bears at least two epoxide groups per molecule and comprises at least one aromatic ring bearing at least one glycidyloxy group. The aromatic compound A1 according to the invention bears at least two epoxide groups per molecule, and one of the at least two epoxide groups may be the epoxide group from the glycidyloxy group bore by the aromatic ring bearing at least one glycidyloxy group.

Suitable aromatic compounds A1 include polyglycidyl ethers of phenols and of polyphenols, such as diglycidyl resorcinol, 1,2,2-tetrakis(glycidyloxyphenyl) ethane, or 1,1,1-tris(glycidyloxyphenyl)methane, diglycidyl ether of bisphenol, such as diglycidyl ether of bisphenol A (bis(4-hydroxyphenyl)-2,2-propane), diglycidyl ether of bisphenol F (bis(4-hydroxyphenyl)methane), diglycidyl ether of bisphenol C (bis(4-hydroxyphenyl)-2,2-dichloroethylene), and diglycidyl ether of bisphenol S (4,4′-sulfonyldiphenol), including oligomers thereof, polyglycidyl ethers of aromatic alcohols, epoxidized novolak compounds, epoxidized cresol novolak compounds, polyglycidyl ether of aminophenols such as triglycidyl aminophenols (TGAP), triglycidyl aminocresol.

Some commercially available aromatic compounds A1 of interest are triglycidyl ethers of p-aminophenol (commercially available as MY 0510 from Huntsman), triglycidyl ethers of m-aminophenol (available as MY 0610 from Huntsman), diglycidyl ethers of bisphenol A based materials such as 2,2-bis(4,4′-dihydroxy phenyl) propane (available as DER 661 from Dow, or as EPON 828 from Momentive), glycidyl ethers of phenol novolak resins (available as DEN 431 or DEN 438 from Dow) and diglycidyl derivatives of dihydroxy diphenyl methane (available as PY 306 from Huntsman).

The aromatic compound A1 is preferably chosen from diglycidyl ethers of bisphenol, such as the diglycidyl ether of bisphenol A (bis(4-hydroxyphenyl)-2,2-propane), the diglycidyl ether of bisphenol F (bis(4-hydroxyphenyl)methane), the diglycidyl ether of bisphenol C (bis(4-hydroxyphenyl)-2,2-dichloroethylene) and the diglycidyl ether of bisphenol S (4,4′-sulfonyldiphenol). In particular, it is bisphenol A diglycidyl ether.

### The Curing Agent A2

Curing agents of epoxy resins are well-known to one skilled in the art. The curing agent A2 can be an amine, such as a primary amine, a secondary amine, or a tertiary amine, a ketimine, a polyamide resin, an imidazole compound, a polymercaptan, an anhydride, a boron-trifluoride-amine complex, a dicyandiamide, an organic acid hydrazide, a photocuring agent or an ultraviolet-curing agent.

Anhydrides suitable as the curing agent A2 include phthalic anhydride, trimellitic anhydride, pyromellitic anhydride, benzophenone tricarboxylic anhydride, ethylene glycol bistrimellitate, glycerol tristrimellitate, maleic anhydride, tetrahydrophthalic anhydride, enomethylene tetrahydrophthalic anhydride, methylendomethyldene tetrahydrophthalic anhydride, dodecenyl succinic anhydride, hexahydrophthalic anhydride, hexahydro-4-methylphthalic anhydride, succinic anhydride, methylcyclohexene dicarboxylic anhydride, alkylstryrene-maleic anhydride copolymer, chlorendic anhydride and polyazelaic polyanhydride.

Exemplary polyamines suitable as the curing agent A2 include diethylenetriamine (DTA), triethylenetetramine (TTA), tetraethylenepentamine (TEPA), dipropenediamine (DPDA), diethylaminopropylamine (DEAPA), bis(hexamethylene)triamine, a mixture comprising bis(hexamethylene)triamine and a non-volatile amine (such as the mixture known as “amine 248”), N-aminoethylpiperazine (N-AEP), menthane diamine (MDA), isophoronediamine (IPDA), 1,3-bis(aminomethyl)cyclohexane, m-xylylenediamine (MXDA), xylylene diamine trimer, metaphenylene diamine (MPDA), diaminodiphenylmethane (DDM), diaminodiphenylsulfone (DDS) and 4,4′-methylenebis(2,6-diethylaniline).

Exemplary imidazole compounds suitable as the curing agent A2 include 2-methylimidazole, 2-phenyl-imidazole, 3-benzyl-2-methylimidazole, 5-methyl-2-phenylimidazole, 2-ethyl-4-methylimidazole, 5-ethyl-2-methylimidazole and 1-cyanoethyl-2-undecylimidazolium trimellitate.

The curing agent A2 is preferably a polyamine, possibly an imidazole compound; the polyamine can be aliphatic or aromatic. More preferably, the curing agent A2 comprises several primary amine groups and/or is an imidazole compound.

### The Optional Additional Compounds A3

As possible additional compounds A3, it can be cited compounds bearing at least two epoxide groups per molecule other than the aromatic compound A1, notably alicyclic or aliphatic compounds bearing at least two epoxide groups per molecule.

As other possible additional compounds A3, it can be cited monoepoxide compounds having one and only one epoxide group per molecule, including aromatic monoepoxy compounds, monoalicyclic epoxy compounds and aliphatic monoepoxy compounds. Exemplary monoepoxide compounds are isobutylene oxide, styrene oxide, 3,3′-bis(chloromethyl)oxacyclobutane and olefinic monoepoxides, such as cyclododecadiene monoepoxide, 3,4-epoxy-1-butene.

### The Reinforcing Fibers

The fiber-reinforced epoxy composite comprises reinforcing fibers. They can be mineral or organic. They may originate from a biological feedstock; so are wood fibers. In accordance with the invention, the reinforcing fibers are advantageously chosen from glass fibers, basalt fibers, aramid fibers, polyester fibers and carbon fibers. Glass fibers exist in many categories, among which notably categories M (for high tensile modulus) and S (for high tensile strength) are worth being cited. Basalt fibers are a material made from extremely fine fibers of basalt, which is composed of the minerals plagioclase, pyroxene, and olivine; they are somewhat similar to glass fibers. Aramid (i.e. aromatic polyamide) fibers include (i) para aramid fibers, in particular poly-paraphenylene terephthalamide fibers (commercially available from DuPont as KEVLAR® fibers) and fibers made of a wholly aromatic polyamide obtained by the polycondensation of terephthaloyl chloride with a mixture of p-phenylenediamine and 3,4′-diaminodiphenylether (available form Teijin as TECHNORA® fibers, and (ii) meta aramid fibers such as NOMEX® fibers (available from DuPont). In polyester fibers, the polyester is preferably a liquid crystal polymer, for example one obtained by the polycondensation of 4-hydroxybenzoic acid and 6-hydroxynaphthalene-2-carboxylic acid; so are VECTRAN™ fibers, as commercialized by Kuraray.

Preferably, the reinforcing fibers are carbon fibers. Carbon fibers (alternatively CF, graphite fiber or graphite fiber) are generally about 5 to 10 μm in diameter. They have several advantages including high stiffness, high tensile strength, low weight-to-strength ratio, high chemical resistance, high temperature tolerance and low thermal expansion. These properties have made carbon fiber very popular in aerospace, civil engineering, military and competition sports. Depending upon the precursor to make the fiber, carbon fiber may be turbostratic or graphitic, or have a hybrid structure with both graphitic and turbostratic parts present.

The carbon fibers may be notably PAN-based carbon fibers or pitch-based carbon fibers.

In the fiber-reinforced epoxy composite, the fibers, in particular the carbon fibers, may be non-woven or they may be patterned in a weave, such as a plain, twill weave, harness satin or fish weave. Each weave contains unique properties that make it great for use in some designs and not a good choice for others.

### Optional Components of the Fiber-Reinforced Epoxy Composite

In addition to the epoxy resin and the reinforcing fiber, the fiber-reinforced epoxy composite can comprise a thermoplastic resin, such as bisphenol A polysulfone (PSU), polyethersulfone (PESU), polyphenylsulfone (PPSU), polyamide (PA), polyamideimide (PAI), polyimide (PI), polyetherimide (PEI), polyester (PE), polyphenylene sulfide (PPS), polyetheretherketone (PEEK), polyetherketoneketone (PEKK), polyolefin (PO) or a combination thereof. In some embodiments, the thermoplastic resin is in particulate form. It can act as toughening agent.

Other possible components of fiber-reinforced epoxy composite include accelerators enhancing or promoting the curing of the epoxy resin, and performance modifying agents such as core shell rubbers, flame retardants, wetting agents, pigments, dyes, UV absorbers, fillers, conducting particles and viscosity modifiers.

### The Solvent S

The solvent S is levoglucosenone and/or a levoglucosenone derivative.

As herein used, the terms “levoglucosenone derivative” are intended to denote a chemical compound which can be synthesized from a levoglucosenone feedstock. The synthesis may require one and only one reaction, or a reaction scheme involving several consecutive reactions (steps) is needed. The number of consecutive reactions (steps) which is needed to synthesize the desired levoglucosenone derivative may vary to a large extent; it can be notably 2, 3, 4, 5, 6 or 7; it is generally of at most 10. Many reaction schemes suitable for synthesizing solvents S in accordance with the present invention are described from p. 28 to p. 38 of the “Supporting Information” accompanying Pacheco's paper and/or are described in the citations referenced in table 14 of the present patent title. The synthesis of the levoglucosenone derivative requires advantageously no more than 7, preferably no more than 5 and still more preferably no more than 3 consecutive reactions. The most preferably, the levoglucosenone derivative can be synthesized from levoglucosenone or from cyrene through one and only one reaction.

### Melting Point and Boiling Point of the Solvent S

The melting point of the solvent S is advantageously below 100° C., preferably of at most 50° C.; more preferably, the solvent S is liquid at room temperature (about 20° C.) and atmospheric pressure (about 1 atm=101.325 kPa).

The boiling point of the solvent S is generally of at least 100° C. It is advantageously of at least 150° C., preferably of at least 175° C., more preferably of at least 200° C. The boiling point of cyrene, as determined experimentally using OECD guideline (1995), Test No. 103 and reported notably in Sigma-Aldrich safety data sheet, is 227° C.

### Hansen Solubility Parameters of the Solvent S

The Hansen solubility parameters of the solvent S, as calculated from the Simplified Molecular-Input Line-Entry System (SMILES) of the solvent S using Yamamoto Molecular Breaking Method with HSPiP software version 5.3.06, comply with all the following requirements:

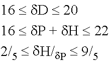

wherein δD, δP and δH are as previously defined.

δD is preferably of at least 17, more preferably of at least 18 and still more preferably of at least 18.5.

Of big importance is δP+δH. Preferably δP+δH is of at least 17, more preferably of at least 18 and still more preferably of at least 19. On the other hand, δP+δH is preferably of at most 21 and more preferably of at most 20.

Of big importance is also the ratio δH/δP. In general, the lower δH/δP is, the higher the swelling effect of the solvent S is. On the other hand, the higher δH/δP is, the higher the exfoliating effect of the solvent S generally is. Whatever the ratio δH/δP of the solvent S is, good results can be achieved when considering the global balance between the swelling effect and the exfoliating effect levels which can be attained. Therefore, the skilled person, if (s)he desires so, can easily adjust δH/δP to a value that is deemed to be optimal for a possible subsequent method, process or use involving the fiber-reinforced epoxy composite that has been treated by the method M, possibly the step b) of the process P¹ as previously described. In particular, δH/δP may be of at least ½ at least ⅔, at least ⅘, at least 1, at least 5/4, at least 3/2 or at least 7/4. Besides, δH/δP may be of most 7/4, at most 3/2, at most 5/4, at most 1, at most ⅘, at most ⅔, at most 4/7 or at most ½.

### Group G1 of Solvents S

Solvents S belonging to a first group G1, which are characterized by δH/δP<1, are generally capable of causing a very high swelling of the fiber-reinforced epoxy composite, combined with a reasonably high exfoliation degree.

In some embodiments, solvents S of the group G1 have a δH/δP which is preferably of most ⅘ and more preferably of at most ⅔. On the other hand, their 1H is preferably of at least ½.

Excellent results were obtained when using cyrene as the solvent S.

### Group G2 of Solvents S

Solvents S belonging to another group G2, which are characterized by δH/δP≥1, are generally capable of causing the exfoliation of the fiber-reinforced epoxy composite to a very high degree, a combined with a reasonably high swelling ratio.

In some embodiments, solvents S of the group G2 have a δH/δP which is preferably at least 5/4 and more preferably of at least 3/2. On the other hand, their δH/δP is preferably of at most 7/4.

Good results are obtained when using levoglucosanol and/or levoglucosenol as the solvent S. Levoglucosanol may be available as threo-levoglucosanol (1,6-anhydro-3,4-dideoxy-β-D-threo-hexopyranose, CAS Registry Number: 39682-49-039682-48-9), erythro-levoglucosanol (1,6-anhydro-3,4-dideoxy-β-D-erythro-hexopyranose, CAS Registry Number: 39682-48-9) or a mixture thereof. Similarly, levoglucosenol may be available as threo-levoglucosenol (1,6-anhydro-3,4-dideoxy-β-D-threo-hex-3-enopyranose, CAS Registry Number: 50705-28-7), erythro-levoglucosenol (1,6-anhydro-3,4-dideoxy-β-D-erythro-hex-3-enopyranose, CAS Registry Number: 58394-28-8) or a mixture thereof.

### Formula of the Solvent S

The solvent S may be of a general formula selected from the group consisting of formulae (I) to (X), as shown here below:

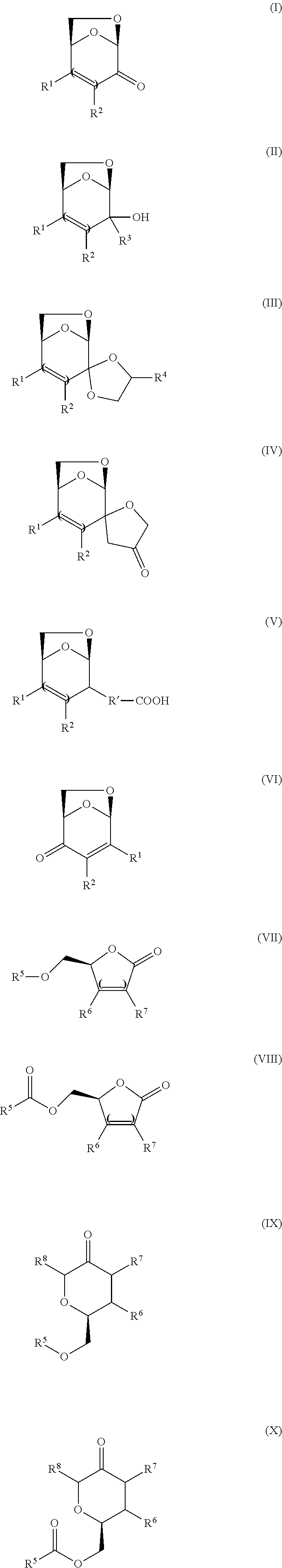

wherein
(-) denotes an optional carbon-carbon bond, which, when present, combines with another carbon-carbon bond to form a carbon-carbon double bond;
R¹, R² and R³, independently from each other, are (i) a hydrogen atom,
(ii) a halogen atom, (iii) C₁-C₄ alkyl, C₁-C₄ alkenyl, C₁-C₄ alkynyl or C₁-C₄ alkoxy, (iv) phenyl which is optionally substituted once or twice by a monovalent group chosen from C₁-C₄ alkyls, C₁-C₄ alkoxys and carboalkoxy groups —COOR wherein R is C₁-C₆ alkyl, or (v)

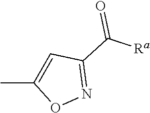

or —R′^{a}—S(═O)—R^{a} or —R′^{a}—S(═O)₂—R^{a}, wherein R^{a} is C₁-C₄ alkyl or phenyl and R^{a} is C₁-C₆ alkanediyl or C₂-C₆ alkenediyl;
R⁴ is hydrogen, C₁-C₄ alkyl or —R′^{d}—OH or wherein R′^{d} is C₁-C₄ alkanediyl;
R⁵ is hydrogen or C₁-C₄ alkyl;
R⁶ and R⁷, independently from each other, are (i) hydrogen, (ii) a halogen atom, (iii) C₁-C₄ alkyl or (iv) phenyl which is optionally substituted once or twice by a monovalent group chosen from C₁-C₄ alkyls, C₁-C₄ alkoxys and carboalkoxy groups —COOR wherein R is C₁-C₆ alkyl, or of which two carbon atoms, adjacent to each other, are substituted so as to form a

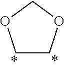

ring with an oxymethyleneoxy group —O—CH₂—O—, wherein the asterisks denote the two adjacent carbon atoms of the phenyl ring;
R⁸ is hydrogen or C₁-C₄ alkoxy;
R′ is C₁-C₆ alkanediyl,
with the proviso that
R¹ and R² can be combined into (i) a C₁-C₆ alkanediyl group, (ii) a C₂-C₆ alkenediyl group, (iii) a —R′^{b}—N═N— group wherein R′^{b} is a C₁-C₄ alkanediyl group of which a carbon atom is optionally further twice substituted to form a spiro linkage as herein shown

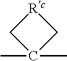

wherein R′^{c} is nil or is C₁-C₄ alkanediyl, or (iv) a —CH₂—C(═O)—CH(—COOR^{b})— group wherein R^{b} is C₁-C₄ alkyl, so that R¹ and R² form a ring with the 2 carbon atoms to which they are attached, and that, when R¹ and R² are combined in such a way and the optional carbon-carbon bond is absent, the carbon atom to which R² is attached can be further substituted by a group R^{2bis} wherein R^{2bis} is C₁-C₄ alkyl or a halogen atom, and that
R⁶ and R⁷ can be combined into a C₁-C₆ alkanediyl group, a C₂-C₆ alkenediyl group or a cycloalkenediyl group of formula

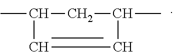

In some embodiments, the solvent S comprises a moiety M¹, a moiety M², a moiety M³ or a moiety M⁴, as detailed hereinafter.

### Embodiments Based on a Moiety M¹

In some embodiments, the solvent S comprises a moiety M¹ of formula (F—I)

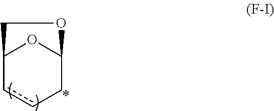

wherein (-) denotes an optional carbon-carbon bond, which, when present, combines with another carbon-carbon bond to form a carbon-carbon double bond, and wherein the carbon atom bearing the asterisk is substituted by a monovalent or divalent group comprises at least one oxygen atom R^{O}. R^{O} is advantageously chosen from (i) oxo (═O), (ii) hydroxyl (—OH), (iii) alkoxy (—OR) wherein R is C₁-C₆ alkyl (preferably, methyl), (iv) an optionally substituted oxyethyleneoxy group (—O—R′^{e}—O—) wherein R′^{e} is ethanediyl which may be substituted by a C₁-C₄ alkyl group (preferably, methyl) or by a C₁-C₄ hydroxyalkyl group —R′^{d}—OH, wherein R′^{d} is C₁-C₄ alkanediyl (preferably, —CH₂—), (v) a group of formula —O—CH₂—C(═O)—CH₂—, (vi) a carboxyalkyl group —R′—COOH wherein R′ is C₁-C₆ alkanediyl (preferably, —CH₂— or —CH₂—CH₂—) and (vii) a carboalkoxyalkyl group —R′—COOR group wherein R′ is C₁-C₆ alkanediyl and R is C₁-C₆ alkyl. So are embodiments E¹ to E⁵ which are detailed hereinafter.

### Embodiment E¹

In a first embodiment E¹, the solvent S is of formula (I)

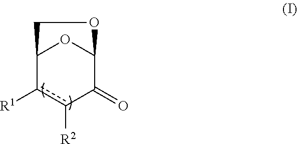

wherein (-) denotes an optional carbon-carbon bond, which, when present, combines with another carbon-carbon bond to form a carbon-carbon double bond, wherein R¹ and R² are as previously described and wherein formula (I) is subject to the previous proviso.

The solvent S may comprise the optional carbon-carbon bond (-), as in formula (Ia)

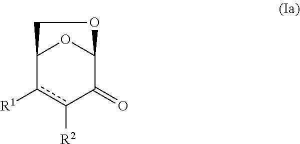

wherein R¹ and R² are as previously described and wherein formula (Ia) is subject to the previous proviso. Alternatively and preferably, the optional carbon-carbon bond (-) is absent from formula (I); then, the solvent S can be represented by formula (Ib)

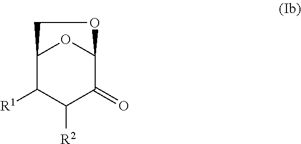

wherein R¹ and R² are as previously described and wherein formula (Ib) is subject to the previous proviso.

In embodiment E¹, R¹ and R², independently from each other, are advantageously H, a halogen atom, C₁-C₄ alkyl, C₁-C₄ alkenyl, C₁-C₄ alkoxy, phenyl, —R′^{a}—S(═O)—R^{a} or —R′^{a}—S(═O)₂—R^{a} wherein R^{a} is C₁-C₄ alkyl or phenyl and R^{a} is C₁-C₆ alkanediyl or C₂-C₆ alkenediyl, with the proviso that
R¹ and R² can be combined into (i) a C₁-C₆ alkanediyl group, (ii) a C₂-C₆ alkenediyl group, (iii) a —R′^{b}—N═N— group wherein R′^{b} is a C₁-C₄ alkanediyl group of which a carbon atom is optionally further twice substituted to form a spiro linkage as herein shown

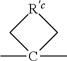

wherein R′^{c} is nil or is C₁-C₄ alkanediyl, or
(iv) a —CH₂—C(═O)—CH(—COOR^{b})— group wherein R^{b} is C₁-C₄ alkyl, so that R¹ and R² form a ring with the 2 carbon atoms to which they are attached, and that, when R¹ and R² are combined in such a way and the optional carbon-carbon bond is absent, the carbon atom to which R² is attached can be further substituted by a group R^{2bis} wherein R^{2bis} is C₁-C₄ alkyl or a halogen atom.

In a first sub-embodiment E¹¹, R¹ and R² are H. The solvent S is then (1S,5R)-6,8-dioxabicyclo[3.2.1]oct-2-en-4-one (commonly and herein referred to as levoglucosenone) or (1S,5R)-6,8-dioxabicyclo[3.2.1]octan-4-one (commonly and herein referred to as cyrene). Their chemical structure, SMILES and Hansen's parameters are provided in table 1.

TABLE 1

| Solvent S | Structure | SMILES | δD | δP | δH |
|---|---|---|---|---|---|
| Levoglucosenone | 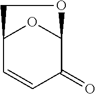 | O═C1C═ CC2COC1O2 | 19.1 | 11.8 | 6.8 |
| Cyrene | 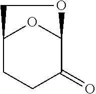 | O═C1C(O C2)OC2CC1 | 18.9 | 12.4 | 7.1 |

(1S,5R)-6,8-dioxabicyclo[3.2.1]oct-2-en-4-one (IUPAC name as computed by Lexichem TK 2.7.0—Pubchem release 2021.05.07), commonly and herein referred to as levoglucosenone, can be indifferently represented by any one of the following three formulae:

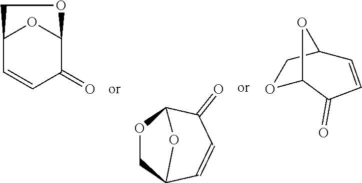 [SMILES: O=C1C=C[C@H]2CO[C@@H]1O2 ; O=C1C=C[C@H]2CO[C@@H]1O2 ; O=C1C=CC2COC1O2]

### Its CAS Registry Number is 37112-31-5.

(1S,5R)-6,8-dioxabicyclo[3.2.1]octan-4-one (IUPAC name as computed by Lexichem TK 2.7.0—Pubchem release 2021.05.07), commonly and herein referred to as cyrene or dihydrolevoglucosenone, can be indifferently represented by any one of the following three formulae:

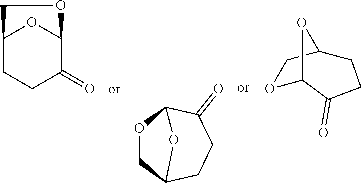 [SMILES: O=C1CC[C@H]2CO[C@@H]1O2 ; O=C1CC[C@H]2CO[C@@H]1O2 ; O=C1CCC2COC1O2]

### Its CAS Registry Number is 53716-82-8.

The preferred solvent S of sub-embodiment E¹¹ is cyrene.

In a second sub-embodiment E¹², R¹ is H and R² differs from H. In this sub-embodiment E¹², R² can be notably C₁-C₄ alkyl or a halogen atom, in particular a halogen atom, more particularly a bromine atom. The chemical structure, SMILES, Hansen's parameters and access code to a source reference of an exemplary compound in accordance with E¹² are provided in table 2.

TABLE 2

| Solvent S* | Structure | SMILES | δD | δP | δH |
|---|---|---|---|---|---|
| S44 [AK-7] | 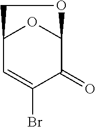 | BrC1═CC2 COC(O2) C1═O | 19.6 | 12 | 7.8 |
| S45 [AK7(m1)] | 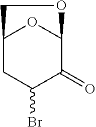 | BrC1CC2 COC(O2) C1═O | 19 | 12.6 | 6.8 |

*Substance label followed, into brackets and italics, by a code based on and providing access to a source reference, as used by Pacheco et al.

In a third sub-embodiment E¹³, R¹ differs from H and R² is H. In this sub-embodiment E¹³, R¹ can be notably C₁-C₄ alkyl, —R′^{a}—S(═O)—R^{a} or —R′^{a}—S(═O)₂—R^{a} wherein R^{a} is C₁-C₆ alkanediyl or C₂-C₆ alkenediyl and R^{a} is C₁-C₄ alkyl or phenyl. In particular, R¹ can be —R′^{a}—S(═O)—R^{a} or —R′^{a}—S(═O)₂—R^{a} wherein R^{a} is as previously described and R^{a} is phenyl. The chemical structure, SMILES, Hansen's parameters and access code to a source reference of exemplary compounds in accordance with E¹³ are provided in table 3.

TABLE 3

| Solvent S* | Structure | SMILES | δD | δP | δH |
|---|---|---|---|---|---|
| S57 [AL-2] | 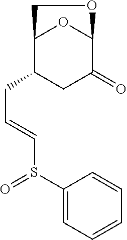 [SMILES: O=C1C[C@H](C/C=C/S(=O)c2ccccc2)[C@H]2CO[C@@H]1O2] | O═S(C-CCC1C C(═O)C2OCC1O2) c3ccccc3 | 19.7 | 12.3 | 5.9 |
| S58 [AL-4] | 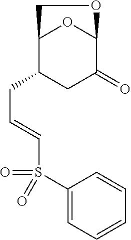 [SMILES: O=C1C[C@H](C/C=C/S(=O)(=O)c2ccccc2)[C@H]2CO[C@@H]1O2] | O═C1CC(CC═C S(═O)(═O) c2ccccc2) C3COC1O3 | 19.3 | 14.2 | 6.6 |

*Substance label and access code to a source reference, from Pacheco et al.

In a fourth sub-embodiment E¹⁴, both R¹ and R² differ from H. In this sub-embodiment E¹⁴, R¹ and R² can be notably C₁-C₄ alkyl, or R¹ and R² can be combined into (i) a C₁-C₆ alkanediyl group (especially, —CH₂—) or (ii) a —R′^{b}—N═N— group wherein R′^{b} is a C₁-C₄ alkanediyl group (especially, —CH₂—) of which a carbon atom is optionally further twice substituted to form a spiro linkage as herein shown

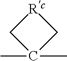

wherein R′^{c} is nil or is C₁-C₄ alkanediyl (preferably, nil), so that R¹ and R² form a ring with the 2 carbon atoms to which they are attached. In sub-embodiment E¹⁴, when R¹ and R² are so combined, the carbon atom to which R² is attached is in general not further substituted by a group R^{2bis}, including when the optional carbon-carbon bond is absent from formula (I), as in formula (Ib). The chemical structure, SMILES, Hansen's parameters and access code(s) to one or more source reference(s) of exemplary compounds in accordance with E¹⁴ are provided in table 4.

TABLE 4

| Solvent | | | | | |
|---|---|---|---|---|---|
| S* | Structure | SMILE | δD | δP | δH |
| S32 [AD-10, AG-1, AH-8] | 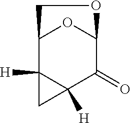 | O═C1C2O CC(O2)C3 CC13 | 18.8 | 11.7 | 5.7 |
| S41 [AJ-2] | 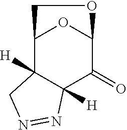 [SMILES: O=C1[C@@H]2OC[C@@H](O2)[C@H]2CN=N[C@@H]12] | O═C1C2O CC(O2)C3 CN═NC13 | 19.6 | 13.9 | 6 |
| S143 [BD-5] | 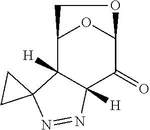 [SMILES: O=C1[C@@H]2OC[C@@H](O2)[C@@H]2[C@H]1N=NC21CC1] | O═C1C2O CC(O2)C3 C1N═NC34CC4 | 19.7 | 12 | 5 |

*Substance label and access code(s) to source reference(s), from Pacheco et al.

### Embodiment E²

In a second embodiment E², the solvent S is of formula (II)

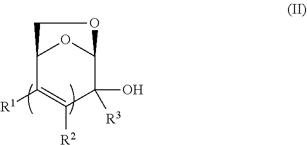

wherein (-) denotes an optional carbon-carbon bond, which, when present, combines with another carbon-carbon bond to form a carbon-carbon double bond, wherein R¹, R² and R³ are as previously described and wherein formula (II) is subject to the previous proviso.

The solvent S may comprise the optional carbon-carbon bond (-) of formula (II), as in formula (IIa)

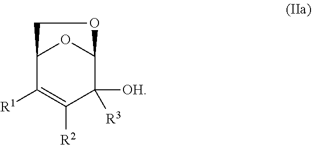

wherein R¹, R² and R³ are as previously described and wherein formula (IIa) is subject to the previous proviso. Alternatively and preferably, the optional carbon-carbon bond (-) is absent from formula (II); then, the solvent S can be represented by formula (IIb)

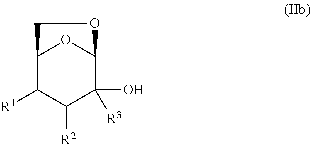

wherein R¹, R² and R³ are as previously described and wherein formula (IIb) is subject to the previous proviso. A solvent S of formula (IIb) in accordance with this proviso can be represented by the formula (IIc) or (IId)

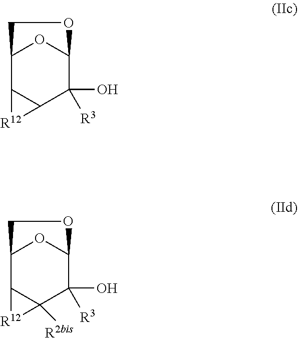

depending on whether the carbon atom to which R² is attached is or is not further substituted by a group R^{2bis} as previously described, wherein R¹² is the divalent group resulting from the combination of R¹ and R² as previously described and R^{2bis} is C₁-C₄ alkyl or a halogen atom.

In embodiment E², R¹, R² and R³, independently from each other, are advantageously H, C₁-C₄ alkyl, C₁-C₄ alkenyl, C₁-C₄ alkynyl, C₁-C₄ alkoxy, a halogen atom,

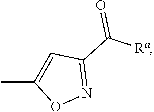

—R′^{a}—S(═O)—R^{a} or —R′^{a}—S(═O)₂—R^{a} wherein R^{a} is C₁-C₄ alkyl or phenyl and R^{a} is C₁-C₆ alkanediyl or C₂-C₆ alkenediyl, with the proviso that
R¹ and R² can be combined into (i) a C₁-C₆ alkanediyl group, (ii) a C₂-C₆ alkenediyl group, (iii) a —R′^{b}—N═N— group wherein R′^{b} is a C₁-C₄ alkanediyl group of which a carbon atom is optionally further twice substituted to form a spiro linkage as herein shown

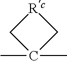

wherein R′^{c} is nil or is C₁-C₄ alkanediyl, or
(iv) a —CH₂—C(═O)—CH(—COOR)— group wherein R^{b} is C₁-C₄ alkyl, so that R¹ and R² form a ring with the 2 carbon atoms to which they are attached, and that, when R¹ and R² are so combined and the optional carbon-carbon bond is absent, the carbon atom to which R² is attached can be further substituted by a group R^{2bis} wherein R^{2bis} is C₁-C₄ alkyl or a halogen atom.

In a first sub-embodiment E²¹, R¹, R² and R³ are H. The chemical structure, SMILES, Hansen's parameters and access code(s) to one or more source reference(s) of solvents S in accordance with E²¹ are provided in table 5.

TABLE 5

| Solvent S* | Structure | SMILES | δD | δP | δH |
|---|---|---|---|---|---|
| Threo- levoglucosenol | 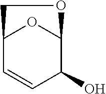 | OC1C═CC2 COC1O2 | 18.2 | 7.9 | 12.8 |
| Threo- levoglucosanol S23 [AD-8m, AE-6a] | 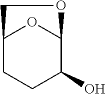 | OC1CCC2 COC1O2 | 18 | 8.5 | 12.6 |
| Erythro- levoglucosenol S24 [AF-8] | 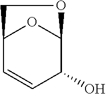 | OC1C═CC2 COC1O2 | 18.2 | 7.9 | 12.8 |
| Erythro- levoglucosanol S25 [AF-8(m)] | 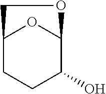 | OC1CCC2 COC1O2 | 18 | 8.5 | 12.6 |

*Substance name and, when available, substance label and access code(s) to source reference(s), from Pacheco et al.

In a second sub-embodiment E²², R¹ and R² are H and R³ differs from H. In this sub-embodiment E²², R³ can be notably C₁-C₄ alkyl, C₁-C₄ alkenyl, C₁-C₄ alkynyl,

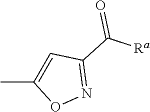

or —R′^{a}—S(═O)—R^{a} wherein R^{a} is C₁-C₄ alkyl or phenyl and R^{a} is C₁-C₆ alkanediyl or C₂-C₆ alkenediyl. When R³ is

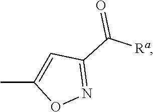

R^{a} is preferably phenyl. When R³ is —R′^{a}—S(═O)—R^{a}, R^{a} is preferably C₁-C₄ alkyl, especially methyl. The chemical structure, SMILES, Hansen's parameters and access code to a source reference of exemplary compounds in accordance with E²² are provided in table 6.

TABLE 6

| Solvent | | | | | |
|---|---|---|---|---|---|
| S* | Structure | SMILES | δD | δP | δH |
| S59 [AL-3] | 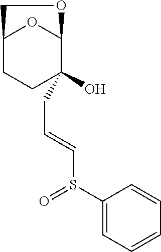 [SMILES: O=S(/C=C/C[C@]1(O)CC[C@H]2CO[C@@H]1O2)c1ccccc1] | O═S(C═CCC 1(O)CC C2COC1O2) c3ccccc3 | 19.7 | 11.1 | 9.1 |
| S72 [AN-1a] | 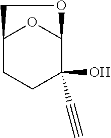 | C#CC1(O) CCC2CO C1O2 | 18.4 | 8.8 | 11 |
| S73 [AN-2a] | 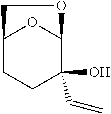 | C═CC1(O) CCC2CO C1O2 | 18.1 | 7.3 | 9.8 |
| S74 [AN- 2a(m)] | 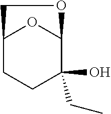 | CCC1(O)C CC2COC1 O2 | 17.8 | 7.4 | 9.8 |
| S75 [AN-6] | 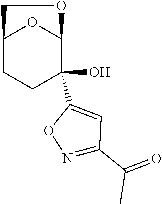 [SMILES: CC(=O)c1cc([C@]2(O)CC[C@H]3CO[C@@H]2O3)on1] | O═C(C) C1═NO C(═C1) C2(O)CC C3COC2O3 | 19 | 12 | 9.8 |

*Substance label and access code to a source reference, from Pacheco et al.

In a third sub-embodiment E²³, R¹ or R² is H but not both of them, and R³ is H. In this sub-embodiment E²³, the group R¹ or R², as the case may be, which differs from H can be notably C₁-C₄ alkyl or C₁-C₄ alkoxy. In sub-embodiment E²³, R² is advantageously H, meaning that R¹ differs then from H; in particular, R¹ can be C₁-C₄ alkoxy. The chemical structure, SMILES, Hansen's parameters and access code to a source reference of an exemplary compound in accordance with E²³ are provided in table 7.

TABLE 7

| Solvent S* | Structure | SMILES | δD | δP | δH |
|---|---|---|---|---|---|
| S26 [AE-7a] | 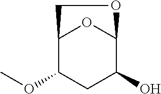 | COC1CC (O)C2OC C1O2 | 17.5 | 8.2 | 10.7 |

*Substance label and access code to a source reference, from Pacheco et al.

In a fourth sub-embodiment E²⁴, R¹ and R² differ from H and R³ is H. In this sub-embodiment E²⁴, R¹ and R², independently from each other, can be notably C₁-C₄ alkyl. In sub-embodiment E²⁴, R¹ and R² can also be combined into a C₁-C₆ alkanediyl group (especially, methylene) or a C₂-C₆ alkenediyl group, so that R¹ and R² form a ring with the 2 carbon atoms to which they are attached, with the proviso that, when R¹ and R² are so combined and the optional carbon-carbon bond is absent from formula (II), the carbon atom to which R² is attached can be further substituted by a group R^{2bis} wherein R^{2bis} is C₁-C₄ alkyl or a halogen atom, as shown in above formula (IId) wherein R¹² is the divalent group resulting from the combination of R¹ and R². The chemical structure, SMILES, Hansen's parameters and access code to a source reference of exemplary compounds in accordance with E²⁴ are provided in table 8.

TABLE 8

| Solvent | | | | | |
|---|---|---|---|---|---|
| S* | Structure | SMILES | δD | δP | δH |
| S31 [AD-9] | 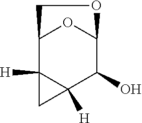 | OC1C2O CC(O2)C3 CC13 | 18 | 7.8 | 11.3 |
| S52 [AK-9] | 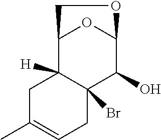 | CC1═CC C2(Br) C(O)C3O CC(O3) C2C1 | 18.1 | 7.1 | 9.2 |

*Substance label and access code to a source reference, from Pacheco et al.

### Embodiments E³, E⁴ and E⁵

In embodiments E³, E⁴ and E⁵, the solvent S is respectively of formula (III)

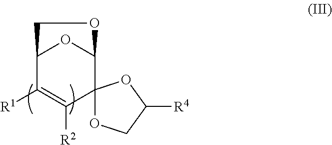

[preferably, of formula (IIIb)

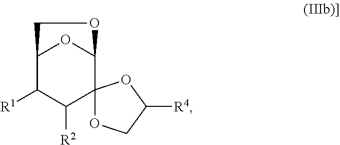

of formula (IV)

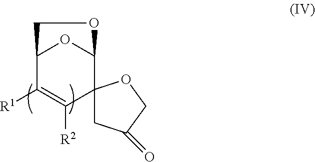

[preferably, of formula (IVb)

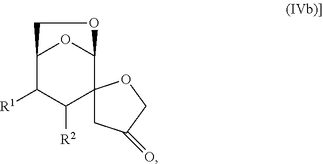

or of formula (V)

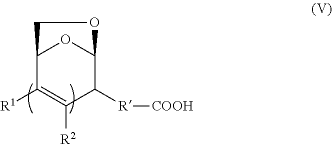

[preferably, of formula (Vb)

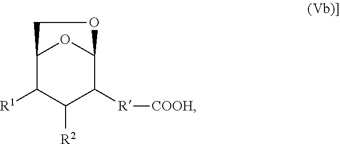

wherein (-) denotes an optional carbon-carbon bond, which, when present, combines with another carbon-carbon bond to form a carbon-carbon double bond, wherein R¹, R² R⁴ and R′ are as previously described and wherein the above formulae are subject to the previous proviso.

In embodiments E³, E⁴ and E⁵, R¹ and R², independently from each other, can be notably H, C₁-C₄ alkyl, C₁-C₄ alkenyl, C₁-C₄ alkoxy or a halogen atom, with the proviso that R¹ and R² can be combined into (i) a C₁-C₆ alkanediyl group, (ii) a C₂-C₆ alkenediyl group or (iii) a —CH₂—C(═O)—CH(—COOR^{b})— group wherein R^{b} is C₁-C₄ alkyl; preferably either R¹ and R² are hydrogen or they are combined into a methylene group. Besides, in embodiment E³, R⁴ is advantageously hydrogen or —CH₂OH.

The chemical structure, SMILES, Hansen's parameters and access code to a source reference of exemplary compounds in accordance with embodiment E³, E⁴ and E⁵ are provided in table 9.

TABLE 9

| | | | | | |
|---|---|---|---|---|---|
| Solvent | | | | | |
| S* | Structure | SMILES | δD | δP | δH |

Embodiment E³

| | | | | | |
|---|---|---|---|---|---|
| S88 [AQ- 18 (m2″″)] | 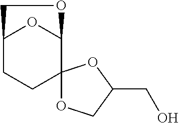 [SMILES: OCC1COC2(CC[C@H]3CO[C@@H]2O3)O1] | OCC1CO C2(CC C3CO C2O3)O1 | 18.4 | 9.4 | 10.3 |
| S113 [AV- VIa] | 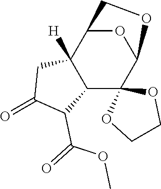 | COC (═O)C1 C(═O) CC2C3 COC(O3) C4(OC CO4) C12 | 18.6 | 10.2 | 6.4 |

Embodiment E⁴

| | | | | | |
|---|---|---|---|---|---|
| S39 [AD- 17(m)] | 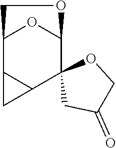 [SMILES: O=C1CO[C@@]2(C1)C1CC1[C@H]1CO[C@@H]2O1] | O═C1CO C2(C1) C3OC C(O3) C4CC24 | 18.8 | 11.8 | 5.2 |

Embodiment E⁵

| | | | | | |
|---|---|---|---|---|---|
| S42 [AH- 23] | 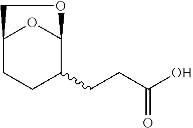 [SMILES: O=C(O)CCC1CC[C@H]2CO[C@@H]1O2] | O═C(O) CCC1C CC2CO C1O2 | 17.8 | 7.2 | 10.8 |

*Substance label and access code to a source reference, from Pacheco et al.

Some solvents S based on a moiety M¹ do not comply with any of the above mentioned formulae (I) to (V), corresponding to embodiments E¹ to E⁵. As an example, it can be mentioned the solvent of formula (XI)

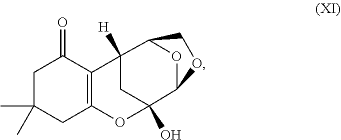 [SMILES: CC1(C)CC(=O)C2=C(C1)O[C@]1(O)C[C@H]2[C@H]2CO[C@@H]1O2]

labelled S119 by Pacheco et al., with AX-II as access code to a source reference, the SMILES of which is O═C1CC(C)(C)CC2=C1C3CC(O)(O2)C4OCC3O4, and having as Hansen's parameters δD=18.6, δP=10.9 and δH=8.6.

### Embodiments Based on a Moiety M²

In some other embodiments, the solvent S comprises a moiety M² of formula (F-II), which is isomeric to the previously described moiety M¹,

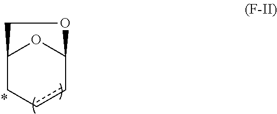

wherein (-) denotes an optional carbon-carbon bond, which, when present, combines with another carbon-carbon bond to form a carbon-carbon double bond, and wherein the carbon atom bearing the asterisk is substituted by a monovalent or divalent group comprising at least one oxygen atom R^{O}. R^{O} is advantageously exactly as specified for the moiety M¹. In particular, R^{O} can be oxo (═O); so is embodiment E⁶.

### Embodiment E⁶

In embodiment E⁶, the solvent S is of formula (VI)

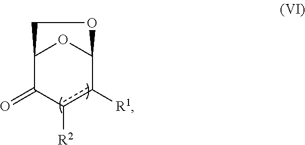

[preferably of formula (VIb)

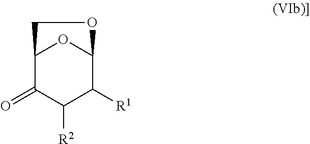

wherein (-) denotes an optional carbon-carbon bond, which, when present, combines with another carbon-carbon bond to form a carbon-carbon double bond, wherein R¹ and R² are as previously described and wherein the formulae (VI) and (VIb) are subject to the previous proviso. R¹ and R² represent advantageously the same atoms or groups of atoms as R¹ and R² do for formula (I). Preferably, both R¹ and R² are hydrogen.

The chemical structure, SMILES, Hansen's parameters and access codes to source references of exemplary compounds in accordance with embodiment E⁶ are provided in table 10.

TABLE 10

| Solvent S* | Structure | SMILES | δD | δP | δH |
|---|---|---|---|---|---|
| S108 [AS-X, AT-3, AU-5] | 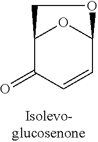 | O═C1C═CC2 OCC1O2 | 19.1 | 11.8 | 6.8 |
| S109 [AS-X(m), AT-3(m), AU-5(m)] | 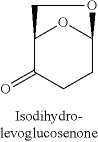 | O═C1CCC2O CC1O2 | 18.9 | 12.4 | 7.1 |

*Substance label and access codes to source references, from Pacheco et al.

### Embodiments Based on a Moiety M³

In some other embodiments, the solvent S comprises a moiety M³ of formula (F—III)

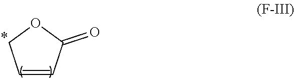

wherein (-) denotes an optional carbon-carbon bond, which, when present, combines with another carbon-carbon bond to form a carbon-carbon double bond, and wherein the carbon atom bearing the asterisk is substituted by a monovalent group comprising at least one oxygen atom R^{O,2}. R^{O,2} is advantageously chosen from (i) a hydroxymethyl group —CH₂OH, (ii) an alkoxymethyl group —CH₂OR^{c} wherein R^{c} is C₁-C₆ alkyl, (iii) a formyloxymethyl group —CH₂—O—C(═O)—H and (iv) an alkanoyloxymethyl group of formula —CH₂—O—C(═O)—R^{c} wherein R^{c} is C₁-C₆ alkyl. So are embodiments E⁷ and E⁸.

### Embodiments E⁷ and E⁸

In embodiments E⁷ and E⁸, the solvent S is respectively of formula (VII)

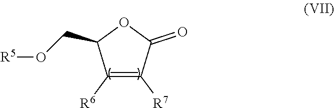

[preferably, of formula (VIIb)

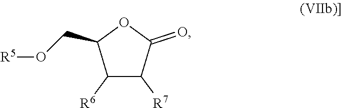

or of formula (VIII)

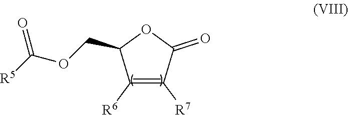

[preferably, of formula (VIIIb)

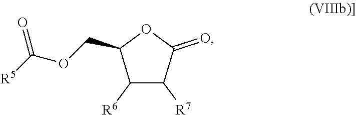

wherein (-) denotes an optional carbon-carbon bond, which, when present, combines with another carbon-carbon bond to form a carbon-carbon double bond, wherein R⁵, R⁶ and R⁷ are as previously described and wherein the above formulae (VII), (VIIb), (VIII) and (VIIIb) are subject to the previous proviso.

In embodiments E⁷ and E⁸, R⁵ is preferably hydrogen or methyl, more preferably hydrogen.

In embodiments E⁷ and E⁸, preferably either (i) R⁶ and R⁷ represent both a hydrogen atom, or (ii) one of R⁶ or R⁷ is a hydrogen atom, while the other one is a phenyl group which is optionally substituted by one monovalent group chosen from C₁-C₄ alkyls (preferably, methyl), C₁-C₄ alkoxys (preferably, methoxy) and carboalkoxy groups —COOR wherein R is C₁-C₆ alkyl (preferably, methyl), or of which two carbon atoms, adjacent to each other, are substituted so as to form a

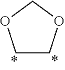

ring with an oxymethyleneoxy group —O—CH₂—O—, wherein the asterisks denote the two adjacent carbon atoms of the phenyl ring, or (iii) R⁶ and R⁷ are combined into a C₁-C₆ alkanediyl group or a C₂-C₆ alkenediyl group.

The chemical structure, SMILES, Hansen's parameters and access code to a source reference of exemplary compounds in accordance with embodiments E⁷ and E⁸ are provided in tables 11 and 12 respectively.

TABLE 11

| | | | | | |
|---|---|---|---|---|---|
| Solvent | | | | | |
| S* | Structure | SMILES | δD | δP | δH |

Embodiment E⁷

| | | | | | |
|---|---|---|---|---|---|
| S6 JAA- HBO (m4)] | 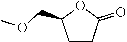 | COC C1CC C(═O) O1 | 16.8 | 10.3 | 6.7 |
| S78 [AP- 2c] | 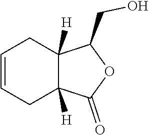 [SMILES: O=C1O[C@H](CO)[C@H]2CC=CC[C@@H]12] | OCC1O C(═O) C2CC═ CCC12 | 17.8 | 8.3 | 10.1 |
| S80 [AP- 2c(m)] | 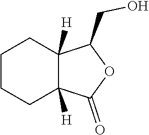 [SMILES: O=C1O[C@H](CO)[C@H]2CCCC[C@@H]12] | OCC1O C(═O) C2CCC CC12 | 17.2 | 7.6 | 9.6 |
| S156 [BE- 14a] | 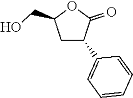 [SMILES: O=C1O[C@H](CO)C[C@H]1c1ccccc1] | OCC1O C(═O) C(C1) c2cc ccc2 | 18.3 | 7.3 | 9.7 |
| S157 [BE- 14b] | 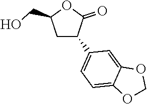 [SMILES: O=C1O[C@H](CO)C[C@H]1c1ccc2c(c1)OCO2] | OCC1O C(═O) C(C1) c2ccc 3O COc3c2 | 19.2 | 7.9 | 10.7 |
| S158 [BE- 14c] | 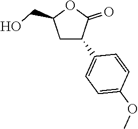 [SMILES: COc1ccc([C@@H]2C[C@@H](CO)OC2=O)cc1] | COc1 ccc (cc1) C2CC (CO)O C2═O | 18.6 | 7.5 | 9.8 |
| S160 [BE- 16a] | 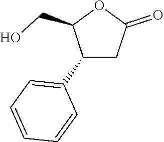 [SMILES: O=C1C[C@H](c2ccccc2)[C@@H](CO)O1] | OCC1 OC (═O) CC1c2 ccccc2 | 18.3 | 7.3 | 9.7 |
| S161 [BE- 16c] | 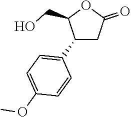 [SMILES: COc1ccc([C@H]2CC(=O)O[C@@H]2CO)cc1] | COc1 ccc (cc1) C2CC (═O)O C2CO | 18.6 | 7.5 | 9.8 |
| S164 [BE- 16i] | 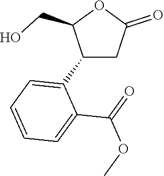 [SMILES: COC(=O)c1ccccc1[C@H]1CC(=O)O[C@@H]1CO] | COC (═O) c1cc ccc1 C2C C(═O) OC2CO | 18.6 | 8.2 | 9.3 |

TABLE 12

| | | | | | |
|---|---|---|---|---|---|
| Solvent | | | | | |
| S* | Structure | SMILES | δD | δP | δH |

Embodiment E⁸

| | | | | | |
|---|---|---|---|---|---|
| S3 [AA- FBO] | 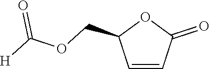 | O═CO CC1C═ CC(═O) O1 | 17.4 | 11.4 | 8.6 |
| S4 [AA- FBO (m)] | 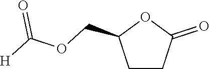 | O═COC C1CC C(═O)O1 | 17.3 | 11.6 | 9.1 |
| S5 [AA- HBO (m2)] | 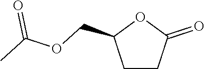 | O═C(C) OCC1 CCC (═O)O1 | 17.2 | 9.4 | 8 |
| S135 [AH- 11] | 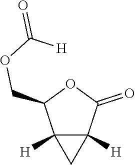 [SMILES: O=COC[C@H]1OC(=O)[C@@H]2C[C@H]12] | O═CO CC1O C(═O)C2 CC12 | 17.6 | 10.6 | 7.9 |

*Substance label and access code to a source reference, from Pacheco et al.

### Embodiments Based on a Moiety M⁴

In some other embodiments, the solvent S comprises a moiety M⁴ of formula (F—IV)

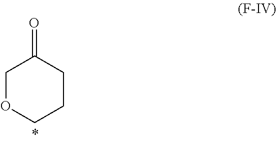

wherein the carbon atom bearing the asterisk is substituted by a monovalent group comprising at least one oxygen atom R^{O,2}. As it is the case for the moiety M³, R^{O,2} of moiety M⁴ is advantageously chosen from (i) a hydroxymethyl group —CH₂OH, (ii) an alkoxymethyl group —CH₂OR^{c} wherein R^{c} is C₁-C₆ alkyl, (iii) a formyloxymethyl group —CH₂—O—C(═O)—H and (iv) an alkanoyloxymethyl group of formula —CH₂—O—C(═O)—R^{c} wherein R^{c} is C₁-C₆ alkyl. So are embodiments E⁹ and E¹⁰.

### Embodiments E⁹ and E¹⁰

In embodiments E⁹ and E¹⁰, the solvent S is respectively of formula (TX)

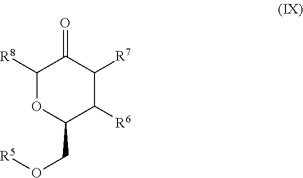

or of formula (X)

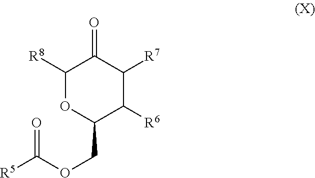

wherein R⁵, R⁶, R⁷ and R⁸ are as previously described and wherein the above formulae (IX) and (X) are subject to the previous proviso.

In embodiments E⁹ and E¹⁰, R⁵ is preferably hydrogen or methyl, especially methyl.

In E⁹ and E¹⁰, preferably either (i) R⁶ and R⁷ represent both a hydrogen atom, or (ii) one of R⁶ or R⁷ is a hydrogen atom, while the other one is a C₁-C₄ alkyl group (preferably, methyl), or (iii) R⁶ and R⁷ are combined into a C₁-C₆ alkanediyl group, a C₂-C₆ alkenediyl group or a cycloalkenediyl group of formula

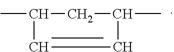

In E⁹ and E¹⁰, R⁸ is often C₁-C₄ alkoxy, especially methoxy.

The chemical structure, SMILES, Hansen's parameters and access code to a source reference of exemplary compounds in accordance with embodiments E⁹ and E¹⁰ are provided in table 13.

TABLE 13

| | | | | | |
|---|---|---|---|---|---|
| Solvent S* | Structure | SMILES | δD | δP | δH |

Embodiment E⁹

| | | | | | |
|---|---|---|---|---|---|
| S13 [AB-VI] | 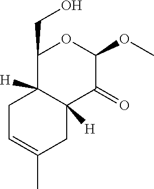 [SMILES: CO[C@@H]1O[C@H](CO)[C@H]2CC=C(C)C[C@H]2C1=O] | COC1OC(CO) C2CC═C(C)C C2C1O | 17.9 | 9.1 | 8.1 |
| S14 [AB-VI(m)] | 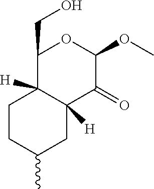 [SMILES: CO[C@@H]1O[C@H](CO)[C@H]2CCC(C)C[C@H]2C1=O] | COC1OC(CO) C2CCC(C)C C2C1═O | 17.5 | 8.7 | 7.4 |
| S93 [AQ- 6(m2)] | 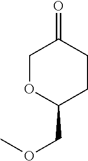 | COCC1OC C(═O)CC1 | 17.8 | 10.4 | 6.1 |
| S96 [AR-9] | 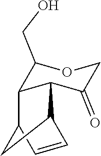 | OCC10C C(═O)C2C3 C═CC(C3)C12 | 18.3 | 9.4 | 8.4 |

Embodiment E¹⁰

| | | | | | |
|---|---|---|---|---|---|
| S95 [AQ- 6(m3)] | 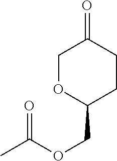 | O═C(C)OCC1 OCC(═O)CC1 | 18.1 | 10.1 | 7.4 |

*Substance label and access code to a source reference, from Pacheco et al.

Some special solvents S are based on a moiety other than M¹, M², M³ or M⁴. As an example, it can be mentioned the solvent of formula (XII)

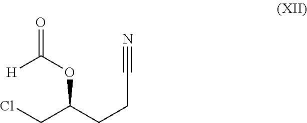

labelled S69 by Pacheco et al., with AM-9a as access code to a source reference, the SMILES of which is N #CCCC(CCl)OC═O, and having as Hansen's parameters δD=17.3, δP=12.8 and δH=8.1.

In the left column of above tables 2 to 12, the solvents S were identified by a label S <number> identical to the label used by Pacheco et al., followed, into brackets and italics, by a code based on and providing access to a source reference, also as used by Pacheco et al. When the code is in the form <letters>-<character(s)>, the letters before the dash constitute a label pointing to the source reference/citation as specified in table 14. The character(s) after the dash point to the compound label used in the original reference. For this reason abbreviations, letters, numbers and Roman numerals are possible; a common format has not been used to help the finding of compounds in their respective references. Where the compound label is followed by (m), this is an original modification to the referenced structure, while (m2) signifies a second structural modification, (m3) a third, and so on. Some compounds have more than one label because they appear in multiple references, hence each compound is also individually labelled.

TABLE 14
Codes of source references, and source references (citations)

| Code | Source references (citations) |
|---|---|
| AA | A. L. Flourat et al., Green Chem., 2015, 17, 404 |
| AB | B. T. Sharipov et al., Russian Journal of Organic Chemistry, 2010, 46, 129. |
| AD | R. A. Novikov et al., Russian Chemical Bulletin International Edition, 2009, |
| | 58, 327 |
| AE | I. P. Tsypysheva et al., Russian Chemical Bulletin International Edition, |
| | 2000, 49, 1237 |
| AF | F. A. Valeev et al., Chemistry of Natural Compounds, 2004, 40, 521 |
| AG | R. R. Rafikov et al., Russian Chemical Bulletin International Edition, 2009, |
| | 58, 2449 |
| AH | R. A. Novikov et al., Russian Chemical Bulletin International Edition, 2010, |
| | 59, 1930 |
| AJ | E. A. Yatsynich et al., Chemistry of Natural Compounds, 2003, 39, 337 |
| AK | T. Nishikawa et al., Tetrahedron, 2001, 57, 3875 |
| AL | L. L. Vasiljeva et al., Russian Chemical Bulletin, 1999, 48, 157 |
| AM | F. A. Valeev et al., Chemistry of Natural Compounds, 2003, 39, 563 |
| AN | Valery K. Brel et al., Mendeleev Commun., 2015, 25, 44 |
| AP | A. N. Davydova et al., Mendeleev Commun., 2015, 25, 271 |
| AQ | A. R. Tagirov et al., Russian Journal of Organic Chemistry, 2015, 51, 569 |
| AR | I. M. Biktagirov et al., Russian Journal of Organic Chemistry, 2015, 51, 576 |
| AS | I. M. Biktagirov et al., Russian Journal of Organic Chemistry, 2014, 50, |
| | 1317 |
| AT | A. M. Sarotti, Carbohydrate Research, 2014, 390, 76 |
| AU | Z. J. Witczak et al., Journal of Carbohydrate Chemistry, 2002, 21, 143 |
| AV | M. M. Iskakova et al., Russian Journal of Organic Chemistry, 2014, 50, 105 |
| AX | Yu. A. Khalilova et al., Russian Journal of Organic Chemistry, 2014, 50, |
| | 117 |
| BD | R. R. Rafikov et al., Russian Chemical Bulletin International Edition, 2009, |
| | 58, 1927 |
| BE | K. P. Stockton et al., Eur. J. Org. Chem., 2015, 6999 |

### Use of the Solvent S

The present invention concerns also a use of the solvent S for swelling the fiber-reinforced epoxy composite, wherein the solvent S and the fiber-reinforced epoxy composite are as previously described.

Preferably, when the fiber-reinforced epoxy composite is a laminate, the use is further for exfoliating the fiber-reinforced epoxy composite laminate.

The swelling ratio, as determined after full immersion of the fiber-reinforced epoxy composite in the solvent S for 5 hours at the treatment temperature Tₜᵣ without stirring, may be 5% or more. It is advantageously of at least 8%, preferably of at least 12%, more preferably of at least 15% and still more preferably of at least 18%.

### Other Aspects of the Invention

### Composition

The present invention concerns also a composition comprising the fiber-reinforced epoxy composite as previously defined and the solvent S as previously defined, such as the composition involved in the previously described method M.

### Process P¹

The present invention concerns also a process P¹ for causing the degradation of an epoxy resin comprised in a fiber-reinforced epoxy composite, said process P¹ comprising:
a) submitting the fiber-reinforced epoxy composite to a pretreatment, said pretreatment comprising applying the method M as previously defined, and
b) submitting the thus pretreated fiber-reinforced epoxy composite to an enzymatic treatment and/or a chemical treatment,
   wherein each of a) and b) is performed once or several times.

In some preferred embodiments, b) comprises submitting the thus pretreated fiber-reinforced epoxy composite to an enzymatic treatment but no chemical treatment, or b) comprises submitting the thus pretreated fiber-reinforced epoxy composite to an enzymatic treatment, then to one or more chemical treatment(s).

An advantage of the enzymatic degradation is that it implies generally mild and safe conditions which have less impact on the environment. As taught by Eliaz et al. in Materials (Basel), 2018, 11, 2123, some bacteria which are potentially able to degrade an epoxy resin are Rhodococcus rhodochrous and Ochrobactrum anthropi.

Insofar as the chemical treatment is concerned, this one comprises advantageously at least one of:
contacting the fiber-reinforced epoxy composite with an aqueous solution of phosphoric acid and/or a salt thereof,
contacting the fiber-reinforced epoxy composite with an organic solution of phosphoric acid and/or a salt thereof,
contacting the fiber-reinforced epoxy composite with an aqueous solution of a strong Bronsted base, and
submitting the fiber-reinforced epoxy composite to an acid digestion treatment.

More preferably, the step b) of the process P¹ comprises
b1) contacting the fiber-reinforced epoxy composite with an enzyme,
b2) contacting the fiber-reinforced epoxy composite with an aqueous solution of phosphoric acid and/or a salt thereof, and
b3) contacting the fiber-reinforced epoxy composite with an aqueous solution of a strong Bronsted base,
   wherein each of b1), b2) and b3) is performed once or several times.

### Use of the Method M

The present invention concerns also a use of the method M as previously described for increasing the diffusion rate of an enzyme or of a chemical compound in an epoxy resin embedded in a fiber-reinforced epoxy composite.

Advantageously, the enzyme or the chemical compound, as the case may be, is selected from enzymes and chemicals capable of reacting with an epoxy resin, especially a cured and/or cross-linked epoxy resin.

Preferably, the enzyme or the chemical compound, as the case may be, is selected from enzymes and chemicals capable of reacting with an epoxy resin in accordance with a reaction or reaction scheme capable of causing the degradation of a fiber-reinforced epoxy composite, especially the epoxy resin and the fiber-reinforced epoxy composite as previously described.

Processes P² and P³

The present invention concerns also a process P² for recovering reinforcing fibers from a fiber-reinforced epoxy composite which comprises:
causing the degradation of the epoxy resin comprised in the fiber-reinforced epoxy composite by the process P¹ as previously described, thereby obtaining a material comprising carbon fibers and epoxy degradation products, and
separating carbon fibers from the thus obtained material.

It comprises also a process P³ for recycling reinforcing fibers which comprises:
recovering carbon fibers from a fiber-reinforced epoxy composite by the process P² as previously described; and
manufacturing a composite material comprising a polymer and the thus recovered carbon fibers, said composite material being identical to or different from the fiber-reinforced epoxy composite material involved in the method M as previously described.

### Advantages of the Present Invention

The present invention has several advantages.

It provides a method as efficient as Ma and Nutt's solvent pretreatment method which does not require the use of a solvent issued from oil industry. It provides a treatment method M as efficient as Ma and Nutt's solvent pretreatment method which is based on a bio-based solvent S, that is to say one which can be manufactured from a renewable biological feedstock. Cyrene, which is or can become a potentially cheap and broadly available solvent, is a suitable and preferred solvent S.

Bio-based solvents S, whatever of Group 1 or 2 as above described, are at least globally as efficient as benzyl alcohol in their ability to facilitate the subsequent chemical degradation of the epoxy contained in epoxy composite laminates, including through swelling (as described by Ma and Nutt) and exfoliation (about by Ma and Nutt remain silent).

Bio-based solvents S of Group 1 as above described make it possible to achieve an increased swelling of the fiber-reinforced composite, which is sometimes desirable to further permeabilize the composites and further reduce the rate-limiting effect of diffusion, especially in case of the most strongly “hardened” composites, which often comprise a highly cross-linked epoxy component. Bio-based solvents S of Group 1 are capable of swelling a fiber-reinforced epoxy composite to a larger extent than what benzyl alcohol can do.

### EXAMPLES

### Experimental Procedure

### Materials

Composite coupons of 1 cm×1 cm×0,334 cm containing 16 sheets of carbon fibers (70.52 wt %) embedded by an epoxy resin (29.48%) produced by the mixture and subsequent polymerization of diglycidylether bisphenol A (DGEBA, as epoxy source) and 4,4′-methylenebis(2,6-diethylaniline (M-DEA, as hardener). The epoxy resin component is a cross-linked network a simplified representation of which could be:

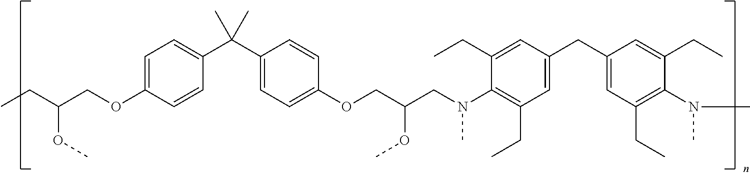

wherein n is an integer corresponding to the number of repeat units of the epoxy resin. The glass transition temperature, as measured by DSC using in accordance ASTM E 1356-08 (2014) on the composite, was 164° C.

Benzyl alcohol (boiling point of 199° C., molecular weight M.W. 108.1 g/mol), hereinafter referred to as “BZA”.

Methyl 4-(dimethylcarbamoyl)-2-methylbutanoate, commercially available from SOLVAY as RHODIASOLV® Polarclean solvent (boiling point of 282° C., M.W. 187.2 g/mol), hereinafter referred to as “PLC”.

Cyrene, commercially available from CIRCA as CYRENE™ solvent (boiling point of 227° C., M.W. 114 g/mol), hereinafter referred to as “CRN”.

### Solvent Treatment

A solvent bath was heated to reach a target temperature (100° C. or 200° C. in the below examples). The mass proportion of composite coupons to the solvent forming the solvent bath was 1:50 (the amount of solvent was high enough to allow for the full immersion of the composite coupons in the solvent bath, thereby ensuring a good reproducibility of the results). When the solvent reached the target temperature, the coupons were fully immersed in the solvent bath without stirring and maintained for 5 hours at such a temperature, still without stirring. Afterwards, the immersed coupons were hot filtrated, and the recovered coupons were washed with alternate portions of Milli-Q® water (18.2 mΩ) and anhydrous ethanol, wherein, for every gram of composite coupon, 200 ml of each water and ethanol were used.

### Swelling Ratio and Exfoliation Degree

To infer the swelling effect of the solvent treatment, it was relied on the mass increase of the composite coupons. Swelling ratio r_{sw} (expressed in %) was calculated using equation Equ. 1:

$${r}_{sw} ( \% ) = \frac{{m}_{final} - {m}_{initial}}{{m}_{final}} \text{.100} \qquad Equ . 1$$

In equation Equ. 1, mᵢₙᵢₜᵢₐₗ and m_{final} are respectively the masses of the composite coupons, before and after their treatment.

To infer the exfoliating effect of the solvent treatment, it was relied on the number of composite sheets that detached from the composite coupons. The exfoliation degree de, (expressed in %) was calculated using equation Equ. 2:

$${d}_{exf} ( \% ) = \frac{{n}_{composite sheets}}{X \cdot {n}_{composite coupons}} \text{.100} \qquad Equ . 2$$

In equation Equ. 2, n_{composite coupons} is the actual number of neat composite coupons treated by a given solvent (which can be one or more than one) and X is the number of carbon fiber sheets piled up to form the composite material coupons. In these examples, each composite coupon was prepared from 16 sheets of piled carbon fibers; therefore, X is 16. In this equation, n_{composite sheets} is the number of composite sheets that detached from the one or more composite coupons for a given solvent after the coupons were subject to the solvent treatment. In practice, any square or near-square structure formed from carbon-fibers embedded by epoxy resin was counted as a detached sheet; n_{composite sheets} could vary from 1 to 15 by coupon, as all untreated composite coupons contained 16 sheets of carbon fibers.

Both swelling and exfoliation are deemed to be key to facilitate the degradation of fiber-reinforced epoxy composites, so solvent treatments causing both effects to occur efficiently are desirable. A performance index PI_{deg} which reflects the global degradation of the composite coupons can be defined as:

$${PI}_{deg} = \frac{1}{100} \cdot {r}_{s w} \cdot {d}_{exf}$$

wherein PI_{deg} is the degradation performance index, and wherein r_{sw} and d_{exf}, both expressed in %, are respectively the swelling ratio and the exfoliation degree as previously defined.

### Results of the Solvent Treatments and Discussion

The results of the solvent treatments are provided in table 15. The comparative examples involving BZA are in accordance with what can be regarded as the closest prior art known to the Applicant, viz. the paper from Ma and Nutt in Polymer Degradation and Stability commented in the background art section. The examples with PLC, an eco-friendly solvent, are also provided for comparison purposes with CRN, but, to the best of the Applicant's knowledge, they do not form part of the prior art; so, their presentation should in no way be construed as an admission by the Applicant that they would form part of the prior art.

TABLE 15

| | Comparative examples | | | | | Invention |
|---|---|---|---|---|---|---|
| | Example | | | | | |
| | CE1 | CE2 | CE3 | CE4 | CE5 | E1 |
| | Solvent | | | | | |
| | BZA | PLC | CRN | BZA | PLC | CRN |
| Treatment temperature | 100 | | | 200 | | |
| Tₜᵣ (° C.) | | | | | | |
| Swelling ratio r_{sw} (%) | 2 | 0.3 | 0.3 | 12 | 13 | 20 |
| Exfoliation degree d_{exf} | 0 | 0 | 0 | 75 | 31 | 50 |
| (%) | | | | | | |
| Degradation perf. index | 0 | 0 | 0 | 9 | 4 | 10 |
| PI_{deg} | | | | | | |
| “Green solvent” attribute | | | | No | Yes | Yes |

Irrespectively of the nature of the solvent, all the treatments CE1 to CE3 made at 100° C., viz. below the glass transition temperature of the epoxy resin matrix, gave poor results, causing very little swelling and no exfoliation of the composite coupons. The Applicant believes that, below the glass transition temperature of the epoxy resin matrix, the molecular chains from the material remained probably frozen, causing sterical hindrance and acting as physical barriers to the solvents.

On the other hand, when treated above the glass transition temperature of the epoxy resin matrix, here at 200° C., all the composite coupons (CE4, CE5 and E1) underwent substantial degradation. The Applicant believes that at such a temperature, the resin free volume probably increased as well as local polymer segment motions, which enabled solvent diffusion in the matrix, favoring the swelling of the resins and mass increase of the composite coupons on the hand, and the fragmentation of the resins through covalent bond breaking and exfoliation of the composite coupons on the other hand.

The treatment with BZA at 200° C., i.e. above the glass transition temperature of the epoxy resin matrix, made it possible to achieve the highest degree of exfoliation. On the other hand, the epoxy coupons were best swollen with CRN (example E1, in accordance with the invention). Nothing in the prior art would have suggested the skilled person that CRN's swelling ability would have much surpassed that of BZA above the glass transition temperature of the epoxy resin matrix; to the contrary, the results obtained at 100° C. would have rather suggested that BZA should have been a better candidate for swelling epoxy resins. Without being bound by any theory, the Applicant believes that the outstandingly high swelling ability of CRN might be due to its lower hydrogen bond forces (δH), when compared to BZA.

Remarkably, treating epoxy coupons with CRN above the glass transition temperature of the epoxy resin, as in example E1, made it also possible to achieve a reasonably high level of exfoliation, yet without reaching that of BZA. Nevertheless, from a global degradation standpoint, including the swelling effect and exfoliating effect attainable levels, CRN qualified unexpectedly as an at least as performing solvent as BZA, as it transpired from CRN's DPI index. Without being bound by any theory, the Applicant believes that that the high global degradation performance of CRN could be achieved thanks to a proper combination of high dispersion forces (δP) with lower hydrogen bond forces (δH).

Last but not least in the CRN/BZA comparison, CRN has the key advantage to be a bio-based solvent which can be synthesized from a low cost and broadly available renewable resource, cellulose, which is obviously not the case of BZA.

Finally, compared to some other green solvents such as PLC, CRN, when used as the solvent above the glass transition temperature of the epoxy resin, exhibited both superior swelling and exfoliation abilities. Nothing in the prior art would suggested such superior degradation performance of CRN over PLC.

1. A method of treatment M of a fiber-reinforced epoxy composite comprising:
contacting the fiber-reinforced epoxy composite with a solvent S at a treatment temperature Tₜᵣ,
wherein the solvent S is levoglucosenone and/or a levoglucosenone derivative of which Hansen solubility parameters, as calculated from the SMILES of the solvent S using Yamamoto Molecular Breaking Method with HSPiP software version 5.3.06, comply with all the following requirements:
$$16 \leq δ D \leq 20$$
$$16 \leq δ P + δ H \leq 22$$
$$\frac{2}{5} \leq \frac{δ H}{δ P} \leq \frac{9}{5}$$
wherein δD is energy from dispersion forces between molecules, δP is energy from dipolar intermolecular forces between molecules, and δH is energy from hydrogen bonds between molecules, all three expressed in MPa^{0.5}, and
wherein the treatment temperature Tₜᵣ exceeds by at least 10° C. the glass transition temperature T_{g} of the fiber-reinforced epoxy composite as determined by Differential Scanning Calorimetry (DSC) in accordance with ASTM E1356-08(2014),
with the proviso that
when no glass transition temperature can be detected by DSC in accordance with ASTM E1356-08(2014), the treatment temperature Tₜᵣ satisfies at least one condition chosen from conditions (c1) to (c3),
wherein condition (c1) is that a glass transition temperature T_{g2} can be determined by Dynamic Mechanical Analysis (DMA) in accordance with ASTM D7028-07(2015) and the treatment temperature Tₜᵣ exceeds by at least 10° C. the glass transition temperature T_{g2},
wherein condition (c2) is that the treatment temperature Tₜᵣ is such that the treatment causes the swelling of the fiber-reinforced epoxy composite by the solvent S with a swelling ratio r_{sw} of at least 8%, as determined after full immersion of the fiber-reinforced epoxy composite in the solvent S for 5 hours at the treatment temperature Tₜᵣ without stirring, and
wherein condition (c3) is that the treatment temperature is of at least 300° C.

2. The method according to claim 1, wherein a glass transition temperature T_{g} can be detected by DSC in accordance with ASTM E1356-08(2014) and which comprises fully immersing the fiber-reinforced epoxy composite in the solvent S for a duration of at least 1 hour at a treatment temperature Tₜᵣ which exceeds by at least 30° C. the glass transition temperature T_{g}.

3. The method according to claim 1, wherein the fiber-reinforced epoxy comprises carbon fibers.

4. The method according to claim 1, wherein the solvent S is characterized by 18≤δP+δH≤20.

5. The method according to claim 1, wherein the solvent S is characterized by δH/δP<1.

6. The method according to claim 5, wherein the solvent S is cyrene.

7. The method according to claim 1, wherein the solvent S is characterized by δH/δP≥1.

8. The method according to claim 7, wherein the solvent S is levoglucosenol and/or levoglucosanol.

9. A method for swelling a fiber-reinforced epoxy composite comprising:
swelling a fiber-reinforced epoxy composite with the solvent S as defined in claim 1.

10. The method according to claim 9, wherein the solvent S is a laminate that exfoliates the fiber-reinforced epoxy composite laminate.

11. A composition comprising a fiber-reinforced epoxy composite and the solvent S as defined in claim 1.

12. A process P¹ for causing the degradation of an epoxy resin comprised in a fiber-reinforced epoxy composite, said process P¹ comprising:
a) submitting the fiber-reinforced epoxy composite to a pretreatment, said pretreatment comprising applying the method M according to claim 1, and
b) submitting the pretreated fiber-reinforced epoxy composite to an enzymatic treatment and/or a chemical treatment,
wherein each of a) and b) is performed once or several times.

13. The method of claim 1, wherein the method M increases the diffusion rate of an enzyme or a chemical compound in an epoxy matrix of a fiber-reinforced epoxy composite.

14. A process P² for recovering reinforcing fibers from a fiber-reinforced epoxy composite which comprises:
causing degradation of an epoxy resin comprised in the fiber-reinforced epoxy composite by the process P¹ according to claim 12, thereby obtaining a material comprising carbon fibers and epoxy degradation products, and
separating the carbon fibers from the thus obtained material.

15. A process P³ for recycling reinforcing fibers which comprises:
recovering the carbon fibers from the fiber-reinforced epoxy composite by the process P² according to claim 14; and
manufacturing a composite material comprising a polymer and the thus recovered carbon fibers, said composite material being identical to or different from the fiber-reinforced epoxy composite material involved in the method M.

16. The method according to claim 9, wherein the solvent S is cyrene.

17. The composition according to claim 11, wherein the fiber-reinforced epoxy composite comprises carbon fibers.

18. The composition according to claim 11, wherein the solvent S is cyrene.
